(19) United States
(12) Patent Application Publication
(10) Pub. No.: US 2022/0137615 A1
(43) Pub. Date: May 5, 2022

(54) Systems and Methods for Dynamic Data Buffering for Autonomous Vehicle Remote Assistance

(71) Applicant: Uber Technologies, Inc., San Francisco, CA (US)

(72) Inventors: Robert Eperjesi, San Francisco, CA (US); Michael Guanran Huang, San Francisco, CA (US); Alex Zhukov, San Francisco, CA (US)

(21) Appl. No.: 17/095,314

(22) Filed: Nov. 11, 2020

Related U.S. Application Data
(60) Provisional application No. 63/109,539, filed on Nov. 4, 2020.

(51) Int. Cl. G05D 1/00

(52) U.S. Cl. CPC G05D 1/0011

(57) ABSTRACT

Systems and methods for dynamic data buffering and provision for vehicle remote assistance are provided. An example computer-implemented method includes obtaining, by a computing system, data associated with an autonomous vehicle. The example method includes detecting, by the computing system, a potential remote assistance event based at least in part on the data associated with the autonomous vehicle. The example method includes initiating, by the computing system, a preliminary remote assistance action based at least in part on the potential remote assistance event. The preliminary remote assistance action includes at least one of transmitting sensor data acquired by the autonomous vehicle to a remote computing system or storing the sensor data onboard the autonomous vehicle. The example method includes communicating, by the computing system after the initiation of the preliminary remote assistance action, a request for remote assistance of the autonomous vehicle.

### PRIORITY CLAIM

This application claims priority to and the benefit of U.S. Provisional Patent Application No. 63/109,539, filed Nov. 4, 2020, which is hereby incorporated by reference in its entirety.

### FIELD

The present disclosure relates generally to intelligent data buffering for improved remote assistance of autonomous vehicles. In particular, the present disclosure relates to the customization of data storage actions and data structures to facilitate improved remote assistance of autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given such knowledge, an autonomous vehicle can navigate through the environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for autonomous vehicle remote assistance. The method includes obtaining, by a computing system including one or more computing devices, data associated with an autonomous vehicle. The method includes detecting, by the computing system, a potential remote assistance event based at least in part on the data associated with the autonomous vehicle. The method includes initiating, by the computing system, a preliminary remote assistance action based at least in part on the potential remote assistance event. The preliminary remote assistance action includes at least one of transmitting sensor data acquired by the autonomous vehicle to a remote computing system or storing the sensor data onboard the autonomous vehicle. The method includes communicating, by the computing system after the initiation of the preliminary remote assistance action, a request for remote assistance of the autonomous vehicle.

Yet another example aspect of the present disclosure is directed to an autonomous vehicle. The autonomous vehicle includes one or more processors and one or more tangible, non-transitory, computer readable media that collectively store instructions that when executed by the one or more processors cause the one or more processors to perform operations. The operations include detecting a potential remote assistance event based at least in part on data associated with the autonomous vehicle. The operations include, in response to detecting the potential remote assistance event, determining one or more data attributes for a preliminary remote assistance action. The operations include initiating a preliminary remote assistance action based at least in part on the one or more data attributes. The preliminary remote assistance action includes at least one of transmitting sensor data acquired by the autonomous vehicle to a remote computing system or storing the sensor data onboard the autonomous vehicle. The operations include, after the initiation of the preliminary remote assistance action, communicating a remote assistance request for remote assistance of the autonomous vehicle.

Another example aspect of the present disclosure is directed to a computing system. The computing system includes one or more processors and one or more tangible, non-transitory, computer readable media that collectively store instructions that when executed by the one or more processors cause the computing system to perform operations. The operations include obtaining a remote assistance request for remote assistance of the autonomous vehicle. The operations include obtaining past sensor data acquired by the autonomous vehicle. The past sensor data was stored onboard the autonomous vehicle or remote from the autonomous vehicle based at least in part on a detection of a potential remote assistance event. The operations include obtaining a live stream of current sensor data acquired by the autonomous vehicle. The operations include generating composite sensor data based at least in part on the past sensor data acquired by the autonomous vehicle and the live stream of the current sensor data acquired by the autonomous vehicle. The operations include generating a user interface based at least in part on the composite sensor data, the user interface allowing for playback of the past sensor data acquired by the autonomous vehicle and viewing of the current sensor data acquired by the autonomous vehicle.

Other example aspects of the present disclosure are directed to systems, methods, vehicles, apparatuses, tangible non-transitory computer-readable media, and memory devices for dynamic customizable data buffering and provision.

The technology described herein can help improve the experience of a rider and/or operator of a vehicle service and decrease associated costs (e.g., to the rider or to the operator), as well as provide other improvements as described herein. Moreover, by effectively coordinating the provision of vehicle services across different modes of transportation, the technology of the present disclosure can help improve the ability of an autonomous vehicle and/or light electric vehicle to effectively provide vehicle services to others and support various members of the community in which the vehicles are operating, including persons with reduced mobility and/or persons that are underserved by other transportation options. Additionally, the technologies of the present disclosure may reduce traffic congestion in communities as well as provide alternate forms of transportation, which may provide environmental benefits.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which references the appended figures, in which:

FIG. 1 depicts an example computing system according to example aspects of the present disclosure;

FIG. 2A depicts an example service entity infrastructure architecture according to example aspects of the present disclosure;

FIG. 2B depicts an example ecosystem for multiple entity integration according to example embodiments of the present disclosure;

FIG. 2C depicts an example system architecture according to example embodiments of the present disclosure;

FIG. 3 depicts an example data structure according to example embodiments of the present disclosure;

FIG. 4 depicts an example of a geographic area according to example embodiments of the present disclosure;

FIG. 5 depicts an example remote assistance user interface according to example aspects of the present disclosure;

FIG. 6 depicts a flowchart illustrating an example method according to example embodiments of the present disclosure;

FIG. 7 depicts example systems with units for performing operations and functions according to example aspects of the present disclosure; and

FIG. 8 depicts example system components according to example aspects of the present disclosure.

### DETAILED DESCRIPTION

Generally, the present disclosure is directed to intelligent data buffering for improved remote assistance of autonomous vehicles. For instance, when an autonomous vehicle encounters a situation that it cannot handle with sufficient confidence, the autonomous vehicle can request assistance from a remote assistance system. Such a situation can be referred to as a remote assistance event. The remote assistance system and/or a remote assistance operator assigned to that request can analyze the vehicle's current situation to determine the best course of action for addressing the remote assistance event.

To help provide greater situational awareness for the remote assistance system/operator, the technology of the present disclosure allows an autonomous vehicle to preemptively buffer sensor data when a potential remote assistance event is detected. The location and the attributes of the stored data can be dynamically customized in real-time based on the circumstances of the autonomous vehicle. For example, an autonomous vehicle can detect a potential remote assistance event based at least in part on data associated with the autonomous vehicle. This data can include, for example, sensor data indicative of the vehicle's surrounding environment (e.g., showing a potential problem in the distance of a roadway), sensor data indicative of the vehicle's interior (e.g., showing a potential problem arising in vehicle's cabin), and/or map data (e.g., encoding certain areas as having a history of remote assistance events). The autonomous vehicle can trigger a preliminary remote assistance action in response to detecting the potential remote assistance event. The preliminary remote assistance action can include an action that occurs prior to the actual remote assistance event or the transmission of a request for assistance associated therewith. For example, the autonomous vehicle can begin to pre-emptively transmit sensor data to a remote system (e.g., a remote assistance system) for storage offboard the autonomous vehicle. This sensor data can be acquired onboard the autonomous vehicle as the autonomous vehicle approaches the potential remote assistance event. Additionally, or alternatively, the autonomous vehicle can begin to buffer the sensor data in a memory onboard the autonomous vehicle. Thereafter, the autonomous vehicle can communicate a request for remote assistance of the autonomous vehicle (e.g., when the vehicle has reached a fallen tree in the roadway, when a problem occurs in the cabin, when the vehicle has reached the problem area encoded in the map data, etc.). With the request (and/or thereafter), the buffered sensor data (e.g., past sensor data, etc.) can be communicated to the remote assistance system and/or presented to a remote assistance operator along with a live stream of current sensor data from the autonomous vehicle. The remote assistance system can generate a visual representation (e.g., video rendering, etc.) and timeline that can be replayed (and/or fast-forwarded) to allow the system/operator to understand what happened to, around, within, etc. the autonomous vehicle leading-up to the remote assistance event. In this way, the intelligent and dynamically adjustable buffering approach of the technology described herein can improve the contextual awareness of a remote assistance system/operator and the efficiency for determining a vehicle action to overcome a remote assistance event. This can improve the processing time and produce more accurate commands that can be quickly implemented by the autonomous vehicle.

More particularly, an autonomous vehicle (e.g., ground-based vehicle, aerial vehicle, light electric vehicle, etc.) can include various systems and devices configured to control the operation of the vehicle. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the vehicle to communicate with a computing system that is remote from the vehicle such as, for example, that of a service entity.

An autonomous vehicle can perform vehicle services for one or more service entities. A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of vehicle service(s) to one or more users. For example, a service entity can offer vehicle service(s) to users via a software application (e.g., on a user computing device), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

An operations computing system of the service entity can help to coordinate the performance of vehicle services by autonomous vehicles. For instance, the operations computing system can include a service platform. The service platform can include a plurality of back-end services and front-end interfaces, which are accessible via one or more APIs. For example, an autonomous vehicle and/or another computing system (that is remote from the autonomous vehicle) can communicate/access the service platform (and its backend services) by calling the one or more APIs. Such components can facilitate secure bidirectional communications between autonomous vehicles and/or the service entity's operations system (e.g., including a data center, etc.).

One of the back-end services provided via the operations computing system (e.g., the service platform) can include a remote assistance service. The remote assistance service can be implemented by a remote assistance system configured to coordinate and provide assistance to an autonomous vehicle that is experiencing a remote assistance event. A remote assistance event can include a situation for which the autonomous vehicle does not have sufficient confidence to (or is unable to) address using its autonomy and/or other onboard systems.

A remote assistance event can be associated with an external environment of the autonomous vehicle. For example, a remote assistance event can include an unexpected fallen tree that is blocking travel way lanes in the direction that the autonomous vehicle is travelling. The autonomous vehicle may be programmed to avoid travel in an oncoming lane (and/or reversing in the current lane) without overriding instructions. Thus, the autonomous vehicle's computing system may have low confidence, high uncertainty etc. in its ability to motion plan around the object, which would require travelling in an oncoming lane (and/or reversing in the current lane).

In some implementations, a remote assistance event can be associated with an interior of the autonomous vehicle. For example, the autonomous vehicle can include interior sensors (e.g., in-cabin cameras, etc.) that are configured to acquire sensor data indicative of the interior of the vehicle and the objects included therein. A remote assistance event associated with the interior of the autonomous vehicle can include, for example, a passenger becoming ill, a damaging event in the vehicle's cabin (e.g., fire, leak, etc.), a conflict between passengers, etc.

The remote assistance system can coordinate and/or perform the evaluation of the vehicle's circumstances and instruct the autonomous vehicle to take an action to address, overcome, bypass, etc. the remote assistance event. In some implementations, the remote assistance system can automatically evaluate the vehicle's circumstances for example, by processing the vehicle's sensor and/or other telemetry data utilizing machine-learned model(s) to determine a recommended action for overcoming the condition associated with the remote assistance event. Additionally, or alternatively, a remote assistance operator can be assigned to evaluate the vehicle's circumstances (e.g., via a user interface, etc.) and determine an appropriate action for the autonomous vehicle to safely address the remote assistance event.

The technology described herein can help improve the efficiency of the remote assistance system/operator in determining the appropriate vehicle actions by providing improved contextual awareness with respect to the autonomous vehicle and the remote assistance event. To help do so, an autonomous vehicle can be configured to recognize when a potential remote assistance event may arise. For instance, an onboard vehicle computing system can obtain data associated with the autonomous vehicle. The data associated with the autonomous vehicle can include at least one of: data associated with a geographic area in which the autonomous vehicle is or will be located, interior sensor data associated with an interior of the autonomous vehicle, or external sensor data associated with a surrounding environment of the autonomous vehicle. The interior sensor data associated with the interior of the autonomous vehicle can include, for example, image data acquired by camera(s) located within (and with a field of view within) the autonomous vehicle. The external sensor data can include, for example, LIDAR, camera, RADAR, and/or other sensor data providing a field of view of the environment surrounding the autonomous vehicles, including the travel ways and objects included in the environment.

The data associated with a geographic area in which the autonomous vehicle is or will be located can include map data and/or other types of data indicative of one or more areas that have historically and/or are predicted to include remote assistance event(s). This can include, for instance, area(s) with obstacles, roadwork, poor travelling condition(s), certain weather, etc. that may be considered remote assistance events for an autonomous vehicle. The identification of these situations may arise from one or more other vehicles (e.g., human-driven, autonomous vehicles, drones, etc.). The map data can be encoded to indicate which area(s) may trigger a remote assistance event such that the autonomous vehicle can pre-emptively identify potential remote assistance events.

The vehicle computing system can detect a potential remote assistance event based at least in part on the data associated with the autonomous vehicle. The detection can be based at least in part on the vehicle's confidence that a remote assistance event will occur. The vehicle computing system can determine a confidence associated with the potential remote assistance event. By way of example, the autonomous vehicle can determine that it is 30% confident that a potential remote assistance event may occur in light of its initial perception of an object in the far distance of the travel way (e.g., it is 30% confident in the detection of a fallen tree that is blocking all lanes in the vehicle's direction of travel and that it may not be able to traverse without exiting the lane(s) associated with its direction of travel). In another example, the autonomous vehicle can determine that it is 75% confident that a potential remote assistance event may occur because the autonomous vehicle is within a certain distance from entering an area previously associated with remote assistance event(s) as indicated in the encoded map data and the vehicle's currently planned route and/or motion trajectory appears to be leading the vehicle to that area.

The vehicle computing system can detect the potential remote assistance event based at least in part on a comparison of the confidence to a threshold. For instance, the vehicle computing system can include a data structure defining one or more thresholds (e.g., confidence thresholds, distance thresholds, etc.) that may trigger a detection of a potential remote assistance event. The threshold(s) may include a first threshold indicative of a first confidence level (e.g., 30%, 40%, 50%, etc.). A vehicle confidence in the occurrence of the potential remote assistance event at or above this first threshold may result in the vehicle computing system detecting a trigger to initiate a preliminary remote assistance action. The threshold(s) can also be associated with distances (e.g., within 1 mile, 2 miles, etc.) from a potential remote assistance event such the vehicle computing system may detect a potential remote assistance event in the event the autonomous vehicle is within that distance (and a current route/motion plan would potentially lead to an area associated with the remote assistance event). As further described herein, the data structure may include one or more additional thresholds that may be used to determine the type and/or characteristics of the preliminary remote assistance action.

The vehicle computing system can initiate a preliminary remote assistance action based at least in part on the detected potential remote assistance event. For example, the vehicle computing system can initiate a preliminary remote assistance action in response to the vehicle's confidence in the occurrence of the potential remote assistance event exceeding the first threshold. The preliminary remote assistance action can include an action that the autonomous vehicle performs in anticipation of a remote assistance event and prior to sending a remote assistance request. The preliminary remote assistance action can include a preemptive buffer of sensor data acquired by the autonomous vehicle prior to communicating a request for remote assistance.

The vehicle computing system can select the type of preliminary remote assistance action for the autonomous vehicle to perform. This can include a first type of preliminary remote assistance action associated with the preemptive storage of sensor data onboard the autonomous vehicle (e.g., “onboard buffering”). Additionally, or alternatively, this can include a second type of preliminary remote assistance action associated with the preemptive storage of sensor data offboard the autonomous vehicle (e.g., “offboard buffering”). For example, the preliminary remote assistance action can include at least one of transmission of sensor data acquired by the autonomous vehicle (e.g., prior to the remote assistance request) to a remote computing system or a storage of the sensor data onboard the autonomous vehicle.

The vehicle computing system can select the type of preliminary remote assistance action based at least in part on the circumstances of the autonomous vehicle. In some implementations, the vehicle computing system can select the preliminary remote assistance action based at least in part on a confidence associated with the potential remote assistance event. For example, the vehicle computing system may have a 35% confidence that a potential remote assistance event will occur (e.g., based on a detection of a potentially fallen tree in the distance). This confidence level may exceed a first threshold (e.g., a 30% confidence threshold). Based at least in part on the confidence associated with the potential remote assistance event exceeding the first threshold, the vehicle computing system can select (and initiate) the first type of preliminary remote assistance. For example, the vehicle computing system can begin to buffer sensor data in a memory onboard the autonomous vehicle.

As the vehicle computing system's confidence in the occurrence of the potential remote assistance event increases the vehicle computing system can select/change to another type of preliminary remote assistance action. As the autonomous vehicle gets closer to, has a better view of, etc. the potential remote assistance event (e.g., the fall tree, etc.) the vehicle computing system can become more confident that the potential remote assistance event will occur. For example, as the autonomous vehicle approaches the fallen tree it may become 80% confident that a remote assistance event will occur because the vehicle is more confident (e.g., due to its better view) that the fallen tree is blocking all lanes in the vehicle's current direction of travel. The vehicle computing system can determine this updated confidence and compare it to another, second threshold (e.g., a 75% confidence threshold). The vehicle computing system can determine that the updated confidence has met or exceeded the second threshold based at least in part on this comparison. The vehicle computing system can select, switch to, initiate, etc. the second type of preliminary remote assistance action based on the updated confidence meeting/exceeding the second threshold. For example, the vehicle computing system can begin to transmit sensor data to a remote computing system (e.g., a remote assistance system, etc.) for storage remote from the autonomous vehicle. The remote computing system can obtain this sensor data (e.g., past sensor data, etc.) and store the sensor data in a memory remote from the autonomous vehicle (e.g. in a buffer and/or other storage medium, etc.).

In some implementations, the vehicle computing system can select a type of preliminary remote assistance action based at least in part on other circumstances of the autonomous vehicle. For instance, the autonomous vehicle can select the type of preliminary remote assistance action based at least in part on one or more communicability factors. The communicability factors could include the signal strength/connectivity between the autonomous vehicle and the remote computing system, the bandwidth, network availability, etc. In the event that a certain communication network (e.g., LTE, etc.) is not available and/or the available telecommunication bandwidth is low (e.g., because the vehicle is sending other data, etc.), the vehicle computing system can select the first type of preliminary assistance action and store data onboard the autonomous vehicle (e.g., in an onboard buffer, etc.). The vehicle computing system can switch to the second type of preliminary remote assistance action (e.g., offboard transmission) in the event communicability factor(s) change/improve.

Initiating the preliminary remote assistance action can also include determining data attribute(s) for the sensor data to be stored. For instance, the vehicle computing system can determine one or more data attributes for the sensor data to be stored (onboard and/or offboard the vehicle) in accordance with the selected preliminary remote assistance action. The data attribute(s) can include a frequency of the sensor data (e.g., a frame rate, sampling rate, etc.), quality of the sensor data (e.g., sharpness, luminosity, consistency, completeness, etc.), a resolution of the sensor data, and/or other sensor data metrics.

In some implementations, the data attribute(s) can be determined based at least in part on an object (e.g., its static/dynamic type, classification, etc.) associated with the potential remote assistance event. By way of example, the vehicle computing system can detect that a static object such as, for example, a fallen tree is within the travel way of the autonomous vehicle. Because the object is static, the motion of the object over time may be less important to the remote assistance system and/or operator. The vehicle computing system can determine that the buffered sensor data should be stored with higher resolution but at lower frame rate. The vehicle computing system may do so because the motion of the fallen tree leading up to its location within the travel way may be of lower importance in determining an appropriate action for the autonomous vehicle, than identifying the tree's location with greater accuracy (e.g., using higher resolution, etc.). In another example, the vehicle computing system can detect that an object, which is typically dynamic (e.g., a vehicle), is blocking the travel way of the autonomous vehicle. Because the object is typically dynamic, the motion of the object over time may of higher importance to the remote assistance system and/or operator. For example, it may be important for the remote assistance system/operator to determine whether the vehicle is temporarily parked (e.g., because an operator of the vehicle left to deliver an item, etc.) or whether it appears that the vehicle will be located within the temporary travel way for an extended time period (e.g., because it is broken down, etc.). The vehicle computing system can determine that the buffered sensor data associated with this potential remote assistance event should be stored with lower resolution but at a higher frame rate because the motion of the vehicle leading up to its location within the travel way may be of higher importance when determining an appropriate action for the autonomous vehicle. In this way, the frequency of the sensor data (and/or other data attribute(s)) can be associated with the type of an object associated with the potential remote assistance event.

In some implementations, the data attribute(s) of the sensor data to be buffered can be based at least in part on other circumstance(s) associated with the autonomous vehicle. For instance, the vehicle computing system can determine one or more data attributes for the sensor data based at least in part on the vehicle computing system's confidence that a potential remote assistance event will occur. One or more of the data attributes can be adjusted as confidence in the occurrence of the potential remote assistance event increases, decreases, etc. For example, the vehicle computing system can determine one or more data attributes for the sensor data based at least in part on a first threshold (e.g., a first confidence threshold). When the vehicle's confidence level meets or exceeds the first threshold, the vehicle computing system can determine that it will start storing and/or transmitting sensor data at a first frame rate (e.g., 1 frame per second, etc.). As the vehicle's confidence in the occurrence of the remote assistance event increases, the vehicle computing system can adjust the data attribute(s) of the sensor data stored/transmitted prior to a remote assistance request. For example, the vehicle computing system can update the one or more data attributes based at least in part on a second threshold (e.g., a second confidence threshold). When the vehicle's confidence level meets or exceeds the second threshold, the vehicle computing system can determine that it will start storing and/or transmitting sensor data at a second frame rate (e.g., 10 frames per second, etc.). This can allow the buffered sensor data to be adapted as the likelihood of a potential remote assistance event increases.

The vehicle computing system can initiate the preliminary remote assistance action by performing the selected type of preliminary remote assistance action with the determined data attributes. For instance, the vehicle computing system can transmit sensor data acquired by the autonomous vehicle to a remote computing system based at least in part on the one or more data attributes and/or store the sensor data onboard the autonomous vehicle based at least in part on the one or more data attributes. This can include transmitting offboard and/or storing onboard the sensor data (acquired prior to sending remote assistance request) with a certain frequency, quality, resolution, etc.

After the initiation of the preliminary remote assistance action, the vehicle computing system can communicate a request for remote assistance of the autonomous vehicle. For instance, the vehicle computing system can communicate a remote assistance request when the autonomous vehicle is uncertain and/or lacks sufficient confidence to handle the potential remote assistance event. This can be due to a lack of confidence in the vehicle's perception/motion prediction of an object associated with the remote assistance event and/or a lack of confidence in the vehicle's motion plan to traverse the object. By way of example, the vehicle computing system can trigger a remote assistance request when it has reached an intersection in which a fallen tree is blocking all lanes of travel in the direction of the autonomous vehicle. The vehicle computing system may lack confidence and/or determine a high cost (e.g., due to motion constraints, etc.) associated with planning the motion of the vehicle to travel in an oncoming lane. As such, the autonomous vehicle can communicate a remote assistance request asking that a remote assistance system/operator provide guidance on the situation. In some implementations, the vehicle can remain stopped while the request is pending.

The remote assistance request can trigger a release of the buffered sensor data for use by the remote assistance system/operator in addressing the remote assistance event. For instance, the vehicle computing system can release the sensor data buffered onboard the autonomous vehicle. The vehicle computing system can initiate the transmission of the sensor data stored onboard the autonomous vehicle to the remote computing system. In some implementations, the autonomous vehicle can begin to communicate this sensor data at the time the remote assistance request is sent. For example, the autonomous vehicle can provide a data package with remote assistance request, the data package can include the sensor data stored onboard the autonomous vehicle in accordance with the preliminary remote assistance action. When the preliminary remote assistance action includes transmitting sensor data acquired by the autonomous vehicle to a remote computing system, the sensor data can be stored by the remote computing system in a buffer remote from the autonomous vehicle. This sensor data can be accessed from the buffer in response to the remote assistance request (e.g., by the remote assistance system, by another system for transmission to the remote assistance system, etc.).

The sensor data stored onboard and/or offboard the autonomous vehicle can be transmitted to/accessed by the remote computing system prior to assignment of the remote assistance request to a remote assistance operator. This can allow the remote assistance system to begin generating composites, timelines, user interfaces, etc. (as further described herein) for the remote assistance operator assigned to the remote assistance event. In some implementations, sensor data stored onboard and/or offboard the autonomous vehicle can be transmitted to/accessed by the remote computing system after assignment of the remote assistance request to a remote assistance operator

In some implementations, communication of the remote assistance request can trigger the transmission of other data from the autonomous vehicle. For example, the vehicle computing system can transmit (e.g., initiate a live stream of, etc.) current sensor data of the autonomous vehicle to the remote computing system. The current sensor data can include data that the autonomous vehicle is presently acquiring (e.g., while it is stopped for the fallen tree). The past sensor data that has been buffered onboard the autonomous vehicle and the current sensor data can be communicated via two different communication streams. The autonomous vehicle can communicate with a remote computing system via one or more networks using one or more protocols (e.g., webRTC protocol, etc.). By way of example, the past sensor data and the current sensor data can be provided via LTE network(s) using two different webRTC streams. The communication streams can be adjusted based at least in part on the data transmissions to help effectively offboard the two different types of sensor data. For example, the vehicle computing system can degrade (e.g., lower bandwidth, adjust associated data attribute(s), etc.) the live sensor stream used for transmitting the current sensor data while the past/buffered sensor data is concurrently transmitted. When transmission of the past sensor data is complete, the vehicle computing system can upgrade the live sensor stream.

The remote assistance system can obtain a remote assistance request for remote assistance of the autonomous vehicle and provide/coordinate such remote assistance. For instance, the remote computing system can obtain past sensor data acquired by the autonomous vehicle. As described herein, this can include the past sensor data that was stored onboard the autonomous vehicle and/or remote from the autonomous vehicle based at least in part on the detection of the potential remote assistance event (e.g., before communicating the remote assistance request, etc.). The remote computing system can obtain the live stream of current sensor data acquired by the autonomous vehicle (e.g., after/while communicating the remote assistance request, etc.). The remote computing system can generate a composite sensor data set based at least in part on the past sensor data acquired by the autonomous vehicle and the live stream of the current sensor data acquired by the autonomous vehicle. For example, the remote computing system can process the past and current sensor data to determine timestamp(s) associated with frames of sensor data (e.g., camera data, etc.). The remote computing system can stitch the frames together in a sequential order to create the composite sensor data. The past sensor data can appear prior to the current sensor data because the timestamp(s) associated with the frames of the past sensor data will be older than those of the current sensor data.

Remote assistance command(s) for the autonomous vehicle can be determined based at least in part on the composite sensor data. For instance, the remote computing system can generate a user interface based at least in part on the composite sensor data. The user interface can allow for viewing/playback of the past sensor data acquired by the autonomous vehicle and viewing of the current sensor data acquired by the autonomous vehicle. For instance, the user interface can include a user interface element (e.g., a playback bar, slider, time scale, etc.) that allows a remote assistance operator to provide user input to view the composite sensor data at different points in time.

The user interface can include a rendering of the composite sensor data. For example, a viewing section of the user interface can include a rendered field of view of the autonomous vehicle's sensors as provided by the past/buffered sensor data and the current sensor data. The rendered view can depict the external environment of the autonomous vehicle and the static/dynamic objects within this environment. This can include a rendering of an object (e.g., fallen tree, vehicle, etc.) contributing to the remote assistance request. Additionally, or alternatively, the rendered view can depict the interior of the autonomous vehicle and the objects within the interior, including any object(s) that may be contributing to the remote assistance request (e.g., smoke, passengers in conflict, etc.). A remote assistance operator can provide user input to the user interface element to manipulate the timeframe of the composite sensor data and the rendered view can depict the sensor data acquired by the vehicle at the user-selected time in the timeframe. Thus, the remote assistance operator can gain valuable context of the events associated with the remote assistance event leading up to the current time.

In some implementation, the user interface can include one or more user interface elements associated with actions that can be performed by the autonomous vehicle to overcome/address the remote assistance event. For example, the user interface may include a button that indicates the vehicle is to travel around a fallen tree (into an oncoming lane). A remote assistance operator may select such an option in the event that this movement by the autonomous vehicle would not place the vehicle, its passengers, and/or objects in the environment in danger. In another example, the user interface may include a button that indicates the vehicle is to queue behind a vehicle that is currently blocking the travel lane. A remote assistance operator may select such an option, for example, in the event that the past sensor data shows that a driver of the vehicle appears to have temporarily left the vehicle (e.g., to make a delivery, etc.). The current sensor data may indicate that the driver appears to be returning to the vehicle. As such, the remote assistance operator may determine that the best course of action includes the autonomous vehicle waiting behind the parking vehicle until the parked vehicle begins to move again. The remote computing system can obtain data indicative of a remote assistance command based at least in part on user input associated with the user interface (e.g., interaction with a particular user interface element, etc.). The remote assistance command can include a vehicle action for the autonomous vehicle to perform. This can be, for example, the vehicle action associated with the user interface element selected by the user.

In some implementations, user interface elements associated with actions that can be performed by the autonomous vehicle can be filtered based at least in part on the past sensor data. For instance, the remote computing system can evaluate the past sensor data (and/or the composite sensor data) and determine that certain action(s) may be not appropriate and/or worthwhile for consideration. By way of example, the remote computing system can evaluate the past sensor data to identify that a fallen tree is blocking all lanes of travel in the direction of the autonomous vehicle. In response, the remote computing system can filter out (and not display) an override “disregard/proceed in lane” action for the remote assistance operator to select to instruct the autonomous vehicle to proceed as if the detected tree was an erroneous/false positive detection.

In some implementations, the remote computing system can determine a remote assistance command without input from a remote assistance operator. For example, the remote assistance system can include one or more machine-learned models (e.g., neural networks, etc.) configured to process the composite sensor data to determine the cause of the remote assistance event (e.g., detect the fallen tree, etc.). For example, the model(s) can be trained to evaluate the past/current sensor data (and map data) to identify that a fallen tree is blocking potential lane(s) of travel for the autonomous vehicle. The remote assistance system can include one or more machine-learned models configured to determine a recommended vehicle action based at least in part on the cause of the remote assistance event (e.g., detect the fallen tree, etc.). For example, the model(s) can be trained to evaluate the past/current sensor data (and map data) to identify that the autonomous vehicle could traverse around the fallen tree by travelling in an oncoming lane and that the autonomous vehicle can do so without high cost/increased risk of danger because there is no oncoming traffic. In some implementations, a remote assistance operator can confirm the automatically determined/recommended action(s).

The remote computing system can communicate the remote assistance command to the autonomous vehicle. The remote assistance command can include data indicative of a vehicle action selected by a remote assistance operator and/or the remote assistance system. The remote assistance command can be communicated (e.g., via the service platform, etc.) directly and/or indirectly to the autonomous vehicle.

The vehicle computing system can obtain the remote assistance command indicative of the vehicle action for the autonomous vehicle and initiate the vehicle action for the autonomous vehicle. For instance, the vehicle computing system can initiate a motion control of the autonomous vehicle in accordance with the vehicle action. This can include, for example, instructing the vehicle's autonomy system to generate a motion plan to travel around the fallen tree by temporarily travelling on an oncoming lane. These instructions can include an override of motion constraint(s) generally applied to the vehicle's motion planning in order to allow the autonomous vehicle to generate such a motion plan. In some implementations, the vehicle computing system can bypass the autonomy system to implement the vehicle action. For example, the remote assistance system can generate a motion plan and/or an ingestible vehicle trajectory and communicate such information with the remote assistance command. The generated motion plan/trajectory can be provided to the vehicle's interface module/controller for implementation by the vehicle's control system(s) (e.g., steering, braking, acceleration, etc.), bypassing the vehicle's autonomy system.

The systems and methods described herein provide a number of technical effects and benefits. More particularly, the systems and methods of the present disclosure provide improved techniques for efficient situational analysis, interfacing, and communication between a service entity and an autonomous vehicle. For instance, by buffering sensor data (acquired by the autonomous vehicle prior to a remote assistance request), the autonomous vehicle and/or a remote computing system (e.g., of a service entity, etc.) can preemptively prepare for a potential remote assistance request. The buffered data can be stored and ready for a remote assistance system in the event of a remote assistance request. As a result, the remote assistance system/remote assistance operator can quickly and efficiently gain improved situational awareness of the circumstances leading-up to the remote assistance request. Moreover, a user interface displaying this past sensor data (as well as current sensor data) allows an operator to quickly and efficiently understand the current situation and evaluate the remote assistance actions for the situation. In this way, the updated remote assistance user interface can increase operator response speed and accuracy, increase the overall efficiency of communications and commands, and improve the reliability of such communications. Ultimately, issues that result in a request for remote assistance can be more quickly resolved, while increasing the safety of the autonomous vehicle, any passengers, as well as the vehicle's surroundings.

Example aspects of the present disclosure can provide an improvement to computing technology, such as autonomous vehicle computing technology. For instance, the systems and methods of the present disclosure provide an improved approach to remote assistance for autonomous operations. For instance, a computing system can obtain data associated with an autonomous vehicle. The computing system can detect a potential remote assistance event based at least in part on the data associated with the autonomous vehicle. The computing system can initiate a preliminary remote assistance action based at least in part on the potential remote assistance event. As described herein, the preliminary remote assistance action can include at least one of transmitting sensor data acquired by the autonomous vehicle to a remote computing system or storing the sensor data onboard the autonomous vehicle. The computing system can communicate, after the initiation of the preliminary remote assistance action, a request for remote assistance of the autonomous vehicle. In this way, the computing system can improve the ability for an autonomous vehicle to receive remote assistance in a quicker and more accurate manner. This improvement in accuracy and efficiency may result in lower power use, lower processing time, and less vehicle downtime (while waiting for a solution to a remote assistance event).

With reference to the figures, example embodiments of the present disclosure will be discussed in further detail.

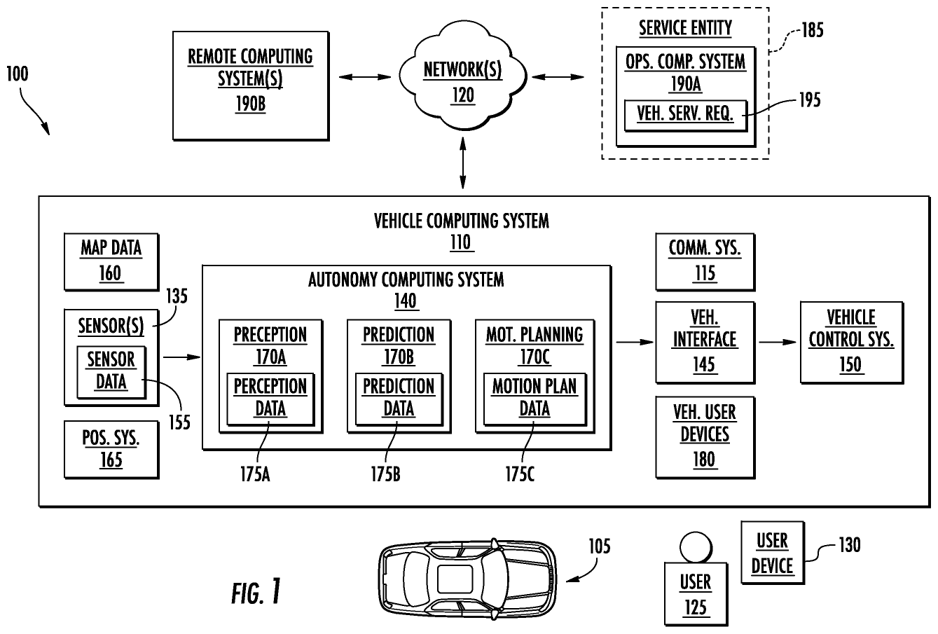

FIG. 1 depicts a block diagram of an example system 100 for controlling and communicating with a vehicle according to example aspects of the present disclosure. As illustrated, FIG. 1 shows a system 100 that can include a vehicle 105 and a vehicle computing system 110 associated with the vehicle 105. The vehicle computing system 100 can be located onboard the vehicle 105 (e.g., it can be included on and/or within the vehicle 105).

The vehicle 105 incorporating the vehicle computing system 100 can be various types of vehicles. For instance, the vehicle 105 can be an autonomous vehicle. The vehicle 105 can be a ground-based autonomous vehicle (e.g., car, truck, bus, etc.). The vehicle 105 can be an air-based autonomous vehicle (e.g., airplane, helicopter, vertical take-off and lift (VTOL) aircraft, etc.). The vehicle 105 can be a lightweight elective vehicle (e.g., bicycle, scooter, etc.). The vehicle 105 can be another type of vehicle (e.g., watercraft, etc.). The vehicle 105 can drive, navigate, operate, etc. with minimal and/or no interaction from a human operator (e.g., driver, pilot, etc.). In some implementations, a human operator can be omitted from the vehicle 105 (and/or also omitted from remote control of the vehicle 105). In some implementations, a human operator can be included in the vehicle 105.

The vehicle 105 can be configured to operate in a plurality of operating modes. The vehicle 105 can be configured to operate in a fully autonomous (e.g., self-driving) operating mode in which the vehicle 105 is controllable without user input (e.g., can drive and navigate with no input from a human operator present in the vehicle 105 and/or remote from the vehicle 105). The vehicle 105 can operate in a semi-autonomous operating mode in which the vehicle 105 can operate with some input from a human operator present in the vehicle 105 (and/or a human operator that is remote from the vehicle 105). The vehicle 105 can enter into a manual operating mode in which the vehicle 105 is fully controllable by a human operator (e.g., human driver, pilot, etc.) and can be prohibited and/or disabled (e.g., temporary, permanently, etc.) from performing autonomous navigation (e.g., autonomous driving, flying, etc.). The vehicle 105 can be configured to operate in other modes such as, for example, park and/or sleep modes (e.g., for use between tasks/actions such as waiting to provide a vehicle service, recharging, etc.). In some implementations, the vehicle 105 can implement vehicle operating assistance technology (e.g., collision mitigation system, power assist steering, etc.), for example, to help assist the human operator of the vehicle 105 (e.g., while in a manual mode, etc.).

To help maintain and switch between operating modes, the vehicle computing system 110 can store data indicative of the operating modes of the vehicle 105 in a memory onboard the vehicle 105. For example, the operating modes can be defined by an operating mode data structure (e.g., rule, list, table, etc.) that indicates one or more operating parameters for the vehicle 105, while in the particular operating mode. For example, an operating mode data structure can indicate that the vehicle 105 is to autonomously plan its motion when in the fully autonomous operating mode. The vehicle computing system 110 can access the memory when implementing an operating mode.

The operating mode of the vehicle 105 can be adjusted in a variety of manners. For example, the operating mode of the vehicle 105 can be selected remotely, off-board the vehicle 105. For example, a remote computing system (e.g., of a vehicle provider and/or service entity associated with the vehicle 105) can communicate data to the vehicle 105 instructing the vehicle 105 to enter into, exit from, maintain, etc. an operating mode. By way of example, such data can instruct the vehicle 105 to enter into the fully autonomous operating mode.

In some implementations, the operating mode of the vehicle 105 can be set onboard and/or near the vehicle 105. For example, the vehicle computing system 110 can automatically determine when and where the vehicle 105 is to enter, change, maintain, etc. a particular operating mode (e.g., without user input). Additionally, or alternatively, the operating mode of the vehicle 105 can be manually selected via one or more interfaces located onboard the vehicle 105 (e.g., key switch, button, etc.) and/or associated with a computing device proximate to the vehicle 105 (e.g., a tablet operated by authorized personnel located near the vehicle 105). In some implementations, the operating mode of the vehicle 105 can be adjusted by manipulating a series of interfaces in a particular order to cause the vehicle 105 to enter into a particular operating mode.

The vehicle computing system 110 can include one or more computing devices located onboard the vehicle 105. For example, the computing device(s) can be located on and/or within the vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 105 (e.g., its computing system, one or more processors, etc.) to perform operations and functions, such as those described herein for controlling an autonomous vehicle, communicating with other computing systems, etc.

The vehicle 105 can include a communications system 115 configured to allow the vehicle computing system 110 (and its computing device(s)) to communicate with other computing devices. The communications system 115 can include any suitable components for interfacing with one or more network(s) 120, including, for example, transmitters, receivers, ports, controllers, antennas, and/or other suitable components that can help facilitate communication. In some implementations, the communications system 115 can include a plurality of components (e.g., antennas, transmitters, and/or receivers) that allow it to implement and utilize multiple-input, multiple-output (MIMO) technology and communication techniques.

The vehicle computing system 110 can use the communications system 115 to communicate with one or more computing device(s) that are remote from the vehicle 105 over one or more networks 120 (e.g., via one or more wireless signal connections). The network(s) 120 can exchange (send or receive) signals (e.g., electronic signals), data (e.g., data from a computing device), and/or other information and include any combination of various wired (e.g., twisted pair cable) and/or wireless communication mechanisms (e.g., cellular, wireless, satellite, microwave, and radio frequency) and/or any desired network topology (or topologies). For example, the network(s) 120 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communication network (or combination thereof) for transmitting data to and/or from the vehicle 105 and/or among computing systems.

In some implementations, the communications system 115 can also be configured to enable the vehicle 105 to communicate with and/or provide and/or receive data and/or signals from a remote computing device associated with a user 125 and/or an item (e.g., an item to be picked-up for a courier service). For example, the communications system 115 can allow the vehicle 105 to locate and/or exchange communications with a user device 130 of a user 125. In some implementations, the communications system 115 can allow communication among one or more of the system(s) on-board the vehicle 105.

As shown in FIG. 1, the vehicle 105 can include one or more sensors 135, an autonomy computing system 140, a vehicle interface 145, one or more vehicle control systems 150, and other systems, as described herein. One or more of these systems can be configured to communicate with one another via one or more communication channels. The communication channel(s) can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel(s).

The sensor(s) 135 can be configured to acquire sensor data 155. The sensor(s) 135 can be external sensors configured to acquire external sensor data. This can include sensor data associated with the surrounding environment of the vehicle 105. The surrounding environment of the vehicle 105 can include/be represented in the field of view of the sensor(s) 135. For instance, the sensor(s) 135 can acquire image and/or other data of the environment outside of the vehicle 105 and within a range and/or field of view of one or more of the sensor(s) 135. The sensor(s) 135 can include one or more Light Detection and Ranging (LIDAR) systems, one or more Radio Detection and Ranging (RADAR) systems, one or more cameras (e.g., visible spectrum cameras, infrared cameras, etc.), one or more motion sensors, one or more audio sensors (e.g., microphones, etc.), and/or other types of imaging capture devices and/or sensors. The one or more sensors can be located on various parts of the vehicle 105 including a front side, rear side, left side, right side, top, and/or bottom of the vehicle 105. The sensor data 155 can include image data (e.g., 2D camera data, video data, etc.), RADAR data, LIDAR data (e.g., 3D point cloud data, etc.), audio data, and/or other types of data. The vehicle 105 can also include other sensors configured to acquire data associated with the vehicle 105. For example, the vehicle 105 can include inertial measurement unit(s), wheel odometry devices, and/or other sensors.

In some implementations, the sensor(s) 135 can include one or more internal sensors. The internal sensor(s) can be configured to acquire sensor data 155 associated with the interior of the vehicle 105. For example, the internal sensor(s) can include one or more cameras, one or more infrared sensors, one or more motion sensors, one or more weight sensors (e.g., in a seat, in a trunk, etc.), and/or other types of sensors. The sensor data 155 acquired via the internal sensor(s) can include, for example, image data indicative of a position of a passenger or item located within the interior (e.g., cabin, trunk, etc.) of the vehicle 105. This information can be used, for example, to ensure the safety of the passenger, to prevent an item from being left by a passenger, confirm the cleanliness of the vehicle 105, remotely assist a passenger, etc.

In some implementations, the sensor data 155 can be indicative of one or more objects within the surrounding environment of the vehicle 105. The object(s) can include, for example, vehicles, pedestrians, bicycles, and/or other objects. The object(s) can be located in front of, to the rear of, to the side of, above, below the vehicle 105, etc. The sensor data 155 can be indicative of locations associated with the object(s) within the surrounding environment of the vehicle 105 at one or more times. The object(s) can be static objects (e.g., not in motion) and/or dynamic objects/actors (e.g., in motion or likely to be in motion) in the vehicle's environment. The sensor(s) 135 can provide the sensor data 155 to the autonomy computing system 140.

In addition to the sensor data 155, the autonomy computing system 140 can obtain map data 160. The map data 160 can provide detailed information about the surrounding environment of the vehicle 105 and/or the geographic area in which the vehicle was, is, and/or will be located. For example, the map data 160 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, and/or other traffic control devices); obstruction information (e.g., temporary or permanent blockages, etc.); event data (e.g., road closures/traffic rule alterations due to parades, concerts, sporting events, etc.); nominal vehicle path data (e.g., indicate of an ideal vehicle path such as along the center of a certain lane, etc.); and/or any other map data that provides information that assists the vehicle computing system 110 in processing, analyzing, and perceiving its surrounding environment and its relationship thereto. In some implementations, the map data 160 can include high definition map data. In some implementations, the map data 160 can include sparse map data indicative of a limited number of environmental features (e.g., lane boundaries, etc.). In some implementations, the map data can be limited to geographic area(s) and/or operating domains in which the vehicle 105 (or autonomous vehicles generally) may travel (e.g., due to legal/regulatory constraints, autonomy capabilities, and/or other factors).

The vehicle 105 can include a positioning system 165. The positioning system 165 can determine a current position of the vehicle 105. This can help the vehicle 105 localize itself within its environment. The positioning system 165 can be any device or circuitry for analyzing the position of the vehicle 105. For example, the positioning system 165 can determine position by using one or more of inertial sensors (e.g., inertial measurement unit(s), etc.), a satellite positioning system, based on IP address, by using triangulation and/or proximity to network access points or other network components (e.g., cellular towers, WIFI access points, etc.) and/or other suitable techniques. The position of the vehicle 105 can be used by various systems of the vehicle computing system 110 and/or provided to a remote computing system. For example, the map data 160 can provide the vehicle 105 relative positions of the elements of a surrounding environment of the vehicle 105. The vehicle 105 can identify its position within the surrounding environment (e.g., across six axes, etc.) based at least in part on the map data 160. For example, the vehicle computing system 110 can process the sensor data 155 (e.g., LIDAR data, camera data, etc.) to match it to a map of the surrounding environment to get an understanding of the vehicle's position within that environment. Data indicative of the vehicle's position can be stored, communicated to, and/or otherwise obtained by the autonomy computing system 140.

The autonomy computing system 140 can perform various functions for autonomously operating the vehicle 105. For example, the autonomy computing system 140 can perform the following functions: perception 170A, prediction 170B, and motion planning 170C. For example, the autonomy computing system 140 can obtain the sensor data 155 via the sensor(s) 135, process the sensor data 155 (and/or other data) to perceive its surrounding environment, predict the motion of objects within the surrounding environment, and generate an appropriate motion plan through such surrounding environment. In some implementations, these autonomy functions can be performed by one or more sub-systems such as, for example, a perception system, a prediction system, a motion planning system, and/or other systems that cooperate to perceive the surrounding environment of the vehicle 105 and determine a motion plan for controlling the motion of the vehicle 105 accordingly. In some implementations, one or more of the perception, prediction, and/or motion planning functions 170A, 170B, 170C can be performed by (and/or combined into) the same system and/or via shared computing resources. In some implementations, one or more of these functions can be performed via different sub-systems. As further described herein, the autonomy computing system 140 can communicate with the one or more vehicle control systems 150 to operate the vehicle 105 according to the motion plan (e.g., via the vehicle interface 145, etc.).

The vehicle computing system 110 (e.g., the autonomy computing system 140) can identify one or more objects within the surrounding environment of the vehicle 105 based at least in part on the sensor data from the sensors 135 and/or the map data 160. The objects perceived within the surrounding environment can be those within the field of view of the sensor(s) 135 and/or predicted to be occluded from the sensor(s) 135. This can include object(s) not in motion or not predicted to move (static objects) and/or object(s) in motion or predicted to be in motion (dynamic objects/actors). The vehicle computing system 110 (e.g., performing the perception function 170C, using a perception system, etc.) can process the sensor data 155, the map data 160, etc. to obtain perception data 175A. The vehicle computing system 110 can generate perception data 175A that is indicative of one or more states (e.g., current and/or past state(s)) of one or more objects that are within a surrounding environment of the vehicle 105. For example, the perception data 175A for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape, object highlighting, etc.); class (e.g., pedestrian class vs. vehicle class vs. bicycle class, etc.), the uncertainties associated therewith, and/or other state information. The vehicle computing system 110 can utilize one or more algorithms and/or machine-learned model(s) that are configured to identify object(s) based at least in part on the sensor data 155. This can include, for example, one or more neural networks trained to identify object(s) within the surrounding environment of the vehicle 105 and the state data associated therewith. The perception data 175A can be utilized for the prediction function 170B of the autonomy computing system 140.

The vehicle computing system 110 can be configured to predict a motion of the object(s) within the surrounding environment of the vehicle 105. For instance, the vehicle computing system 110 can generate prediction data 175B associated with such object(s). The prediction data 175B can be indicative of one or more predicted future locations of each respective object. For example, the prediction system 170B can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175B can be indicative of the speed and/or acceleration at which the respective object is predicted to travel along its associated predicted motion trajectory. The vehicle computing system 110 can utilize one or more algorithms and/or machine-learned model(s) that are configured to predict the future motion of object(s) based at least in part on the sensor data 155, the perception data 175A, map data 160, and/or other data. This can include, for example, one or more neural networks trained to predict the motion of the object(s) within the surrounding environment of the vehicle 105 based at least in part on the past and/or current state(s) of those objects as well as the environment in which the objects are located (e.g., the lane boundary in which it is travelling, etc.). The prediction data 175B can be utilized for the motion planning function 170C of the autonomy computing system 140.

The vehicle computing system 110 can determine a motion plan for the vehicle 105 based at least in part on the perception data 175A, the prediction data 175B, and/or other data. For example, the vehicle computing system 110 can generate motion planning data 175C indicative of a motion plan. The motion plan can include vehicle actions (e.g., speed(s), acceleration(s), other actions, etc.) with respect to one or more of the objects within the surrounding environment of the vehicle 105 as well as the objects' predicted movements. The motion plan can include one or more vehicle motion trajectories that indicate a path for the vehicle 105 to follow. A vehicle motion trajectory can be of a certain length and/or time range. A vehicle motion trajectory can be defined by one or more waypoints (with associated coordinates). The planned vehicle motion trajectories can indicate the path the vehicle 105 is to follow as it traverses a route from one location to another. Thus, the vehicle computing system 110 can consider a route/route data when performing the motion planning function 170C.

The motion planning function 170C can implement an optimization algorithm, machine-learned model, etc. that considers cost data associated with a vehicle action as well as other objective functions (e.g., cost functions based on speed limits, traffic lights, etc.), if any, to determine optimized variables that make up the motion plan. The vehicle computing system 110 can determine that the vehicle 105 can perform a certain action (e.g., pass an object, etc.) without increasing the potential risk to the vehicle 105 and/or violating any traffic laws (e.g., speed limits, lane boundaries, signage, etc.). For instance, the vehicle computing system 110 can evaluate the predicted motion trajectories of one or more objects during its cost data analysis to help determine an optimized vehicle trajectory through the surrounding environment. The motion planning function 170C can generate cost data associated with such trajectories. In some implementations, one or more of the predicted motion trajectories and/or perceived objects may not ultimately change the motion of the vehicle 105 (e.g., due to an overriding factor). In some implementations, the motion plan may define the vehicle's motion such that the vehicle 105 avoids the object(s), reduces speed to give more leeway to one or more of the object(s), proceeds cautiously, performs a stopping action, passes an object, queues behind/in front of an object, etc.

The vehicle computing system 110 can be configured to continuously update the vehicle's motion plan and a corresponding planned vehicle motion trajectory. For example, in some implementations, the vehicle computing system 110 can generate new motion planning data 175C/motion plan(s) for the vehicle 105 (e.g., multiple times per second, etc.). Each new motion plan can describe a motion of the vehicle 105 over the next planning period (e.g., next several seconds, etc.). Moreover, a new motion plan may include a new planned vehicle motion trajectory. Thus, in some implementations, the vehicle computing system 110 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 105.

The vehicle computing system 110 can cause the vehicle 105 to initiate a motion control in accordance with at least a portion of the motion planning data 175C. A motion control can be an operation, action, etc. that is associated with controlling the motion of the vehicle 105. For instance, the motion planning data 175C can be provided to the vehicle control system(s) 150 of the vehicle 105. The vehicle control system(s) 150 can be associated with a vehicle interface 145 that is configured to implement a motion plan. The vehicle interface 145 can serve as an interface/conduit between the autonomy computing system 140 and the vehicle control systems 150 of the vehicle 105 and any electrical/mechanical controllers associated therewith. The vehicle interface 145 can, for example, translate a motion plan into instructions for the appropriate vehicle control component (e.g., acceleration control, brake control, steering control, etc.). By way of example, the vehicle interface 145 can translate a determined motion plan into instructions to adjust the steering of the vehicle 105 “X” degrees, apply a certain magnitude of braking force, increase/decrease speed, etc. The vehicle interface 145 can help facilitate the responsible vehicle control (e.g., braking control system, steering control system, acceleration control system, etc.) to execute the instructions and implement a motion plan (e.g., by sending control signal(s), making the translated plan available, etc.). This can allow the vehicle 105 to autonomously travel within the vehicle's surrounding environment.

The vehicle computing system 110 can store other types of data. For example, an indication, record, and/or other data indicative of the state of the vehicle (e.g., its location, motion trajectory, health information, etc.), the state of one or more users (e.g., passengers, operators, etc.) of the vehicle, and/or the state of an environment including one or more objects (e.g., the physical dimensions and/or appearance of the one or more objects, locations, predicted motion, etc.) can be stored locally in one or more memory devices of the vehicle 105. Additionally, the vehicle 105 can communicate data indicative of the state of the vehicle, the state of one or more passengers of the vehicle, and/or the state of an environment to a computing system that is remote from the vehicle 105, which can store such information in one or more memories remote from the vehicle 105. Moreover, the vehicle 105 can provide any of the data created and/or stored onboard the vehicle 105 to another vehicle.

The vehicle computing system 110 can include the one or more vehicle user devices 180. For example, the vehicle computing system 110 can include one or more user devices with one or more display devices located onboard the vehicle 105. A display device (e.g., screen of a tablet, laptop, and/or smartphone) can be viewable by a user of the vehicle 105 that is located in the front of the vehicle 105 (e.g., driver's seat, front passenger seat). Additionally, or alternatively, a display device can be viewable by a user of the vehicle 105 that is located in the rear of the vehicle 105 (e.g., a back-passenger seat). The user device(s) associated with the display devices can be any type of user device such as, for example, a table, mobile phone, laptop, etc. The vehicle user device(s) 180 can be configured to function as human-machine interfaces. For example, the vehicle user device(s) 180 can be configured to obtain user input, which can then be utilized by the vehicle computing system 110 and/or another computing system (e.g., a remote computing system, etc.). For example, a user (e.g., a passenger for transportation service, a vehicle operator, etc.) of vehicle 105 can provide user input to adjust a destination location of vehicle 105. The vehicle computing system 110 and/or another computing system can update the destination location of the vehicle 105 and the route associated therewith to reflect the change indicated by the user input.

The vehicle 105 can be configured to perform vehicle services for one or a plurality of different service entities 185. A vehicle 105 can perform a vehicle service by, for example and as further described herein, travelling (e.g., traveling autonomously) to a location associated with a requested vehicle service, allowing user(s) and/or item(s) to board or otherwise enter the vehicle 105, transporting the user(s) and/or item(s), allowing the user(s) and/or item(s) to deboard or otherwise exit the vehicle 105, etc. In this way, the vehicle 105 can provide the vehicle service(s) for a service entity to a user.

A service entity 185 can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services. The vehicle services can be wholly performed by the vehicle 105 (e.g., travelling from the user/item origin to the ultimate destination, etc.) or performed by one or more vehicles and/or modes of transportation (e.g., transferring the user/item at intermediate transfer points, etc.).

An operations computing system 190A of the service entity 185 can help to coordinate the performance of vehicle services by autonomous vehicles. The operations computing system 190A can include and/or implement one or more service platforms of the service entity. The operations computing system 190A can include one or more computing devices. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the operations computing system 190A (e.g., it's one or more processors, etc.) to perform operations and functions, such as those described herein matching users and vehicles/vehicle fleets, deploying vehicles, facilitating the provision of vehicle services via autonomous vehicles, etc.

A user 125 can request a vehicle service from a service entity 185. For example, the user 125 can provide user input to a user device 130 to request a vehicle service (e.g., via a user interface associated with a mobile software application of the service entity 185 running on the user device 130). The user device 130 can communicate data indicative of a vehicle service request 195 to the operations computing system 190A associated with the service entity 185 (and/or another associated computing system that can then communicate data to the operations computing system 190A). The vehicle service request 195 can be associated with a user. The associated user can be the one that submits the vehicle service request (e.g., via an application on the user device 130). In some implementations, the user may not be the user that submits the vehicle service request. The vehicle service request can be indicative of the user. For example, the vehicle service request can include an identifier associated with the user and/or the user's profile/account with the service entity 185. The vehicle service request 195 can be generated in a manner that avoids the use of personally identifiable information and/or allows the user to control the types of information included in the vehicle service request 195. The vehicle service request 195 can also be generated, communicated, stored, etc. in a secure manner to protect information.

The vehicle service request 195 can indicate various types of information. For example, the vehicle service request 195 can indicate the type of vehicle service that is desired (e.g., a transportation service, a delivery service, a courier service, etc.), one or more locations (e.g., an origin location, a destination location, etc.), timing constraints (e.g., pick-up time, drop-off time, deadlines, etc.), and/or geographic constraints (e.g., to stay within a certain area, etc.). The service request 195 can indicate a type/size/class of vehicle such as, for example, a sedan, an SUV, luxury vehicle, standard vehicle, etc. The service request 195 can indicate a product of the service entity 185. For example, the service request 195 can indicate that the user is requesting a transportation pool product by which the user would potentially share the vehicle (and costs) with other users/items. In some implementations, the service request 195 can explicitly request for the vehicle service to be provided by an autonomous vehicle or a human-driven vehicle. In some implementations, the service request 195 can indicate a number of users that will be riding in the vehicle/utilizing the vehicle service. In some implementations, the service request 195 can indicate preferences/special accommodations of an associated user (e.g., music preferences, climate preferences, wheelchair accessibility, etc.) and/or other information.

The operations computing system 190A of the service entity 185 can process the data indicative of the vehicle service request 195 and generate a vehicle service assignment that is associated with the vehicle service request. The operations computing system can identify one or more vehicles that may be able to perform the requested vehicle services to the user 195. The operations computing system 190A can identify which modes of transportation are available to a user for the requested vehicle service (e.g., light electric vehicles, human-drive vehicles, autonomous vehicles, aerial vehicle, etc.) and/or the number of transportation modes/legs of a potential itinerary of the user for completing the vehicle service (e.g., single or plurality of modes, single or plurality of legs, etc.). For example, the operations computing system 190A can determined which autonomous vehicle(s) are online with the service entity 185 (e.g., available for a vehicle service assignment, addressing a vehicle service assignment, etc.) to help identify which autonomous vehicle(s) would be able to provide the vehicle service.

The operations computing system 190A and/or the vehicle computing system 110 can communicate with one or more other computing systems 190B that are remote from the vehicle 105. This can include, for example, computing systems associated with government functions (e.g., emergency services, regulatory bodies, etc.), computing systems associated with vehicle providers other than the service entity, computing systems of other vehicles (e.g., other autonomous vehicles, aerial vehicles, etc.). Communication with the other computing systems 190B can occur via the network(s) 120.

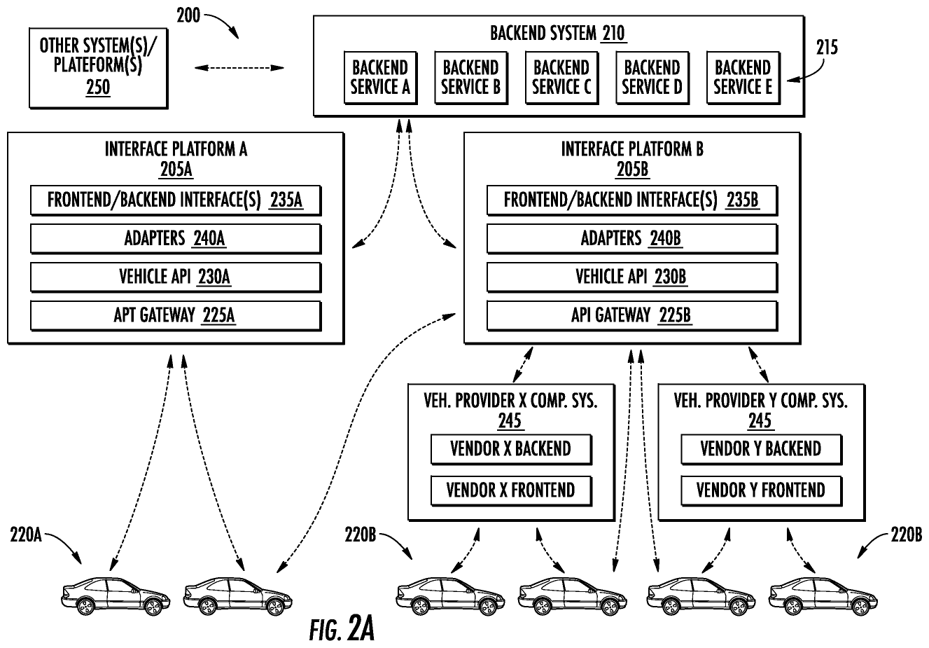

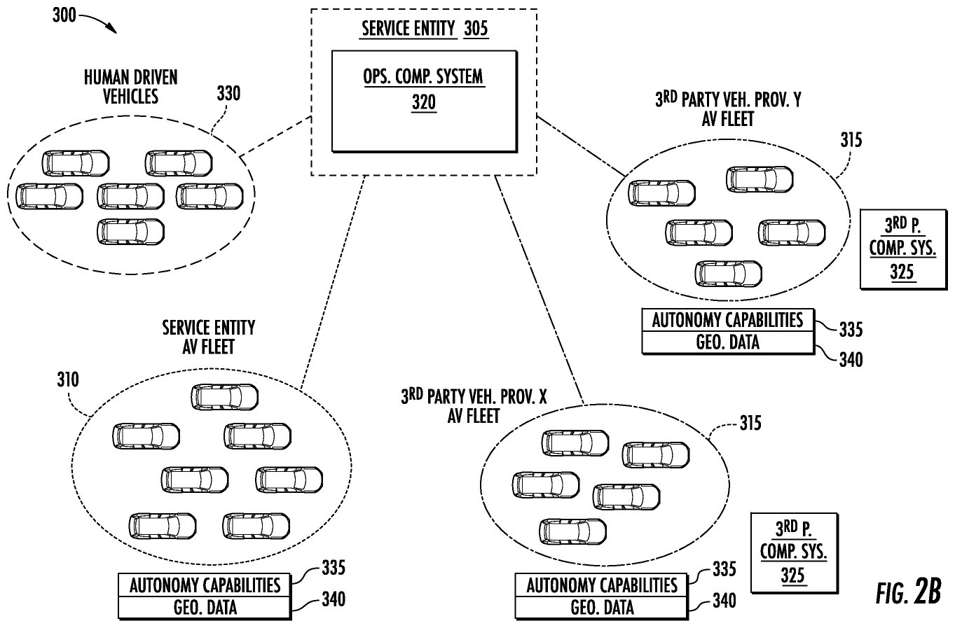

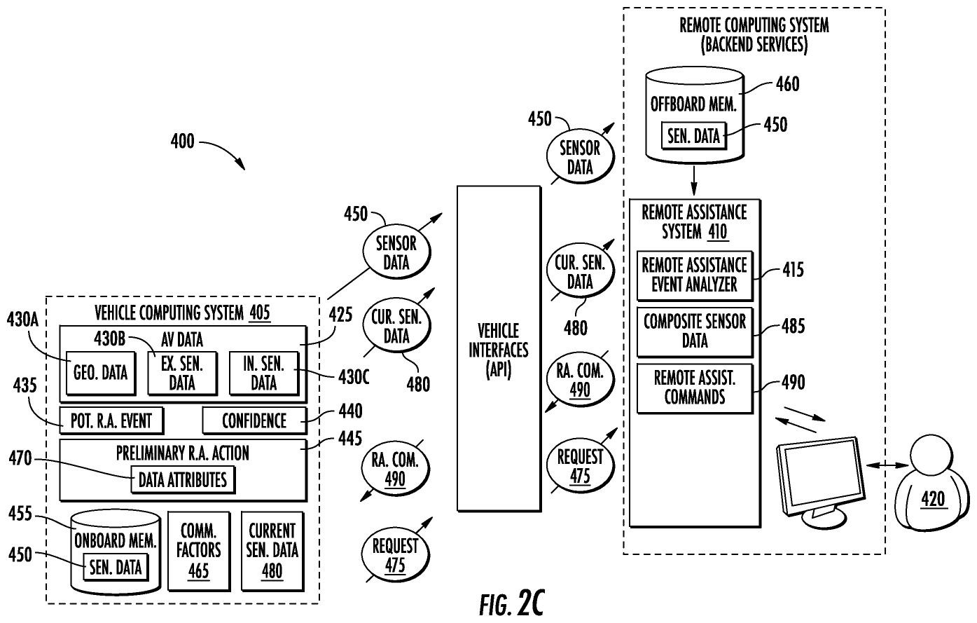

FIG. 2A depicts an example service infrastructure 200 according to example embodiments of the present disclosure. The service infrastructure 200 can include one or more systems, interfaces, and/or other components that can be included in operations computing systems of the service entity for coordinating vehicle services and managing/supporting the autonomous vehicle associated therewith. The service infrastructure 200 can represent, for example, the architecture of a service platform of the operations computing system for coordinating and providing one or more vehicle services (e.g., via autonomous vehicle(s), etc.).

The service infrastructure 200 of an operations computing system can include a first application programming interface platform 205A, a second application programming interface application platform 205B, and/or a backend system 210 with one or a plurality of backend services 215. These components can allow the service infrastructure 200 (e.g., the operations computing system) to communicate with one or more autonomous vehicles and/or one or more other systems.

The first application programming interface platform 205A can facilitate communication with one or more autonomous vehicles of the service entity. For example, as described herein, the service entity may own, lease, etc. a fleet of autonomous vehicles 220A that can be managed by the service entity (e.g., its backend services) to provide one or more vehicle services. The autonomous vehicle(s) 220A can be utilized by the service entity to provide the vehicle service(s) and can be included in the fleet of the service entity. Such autonomous vehicle(s) may be referred to as “service entity autonomous vehicles” or “first party autonomous vehicles.”

The first application programming interface platform 205A can include a number of components to help facilitate the support, coordination, and management of the first party autonomous vehicles 220A associated with the service entity. The first application programming interface platform 205A (e.g., a private platform, etc.) can provide access to one or more backend services 215 that are available to the first party autonomous vehicles 220A. To help do so, the first application programming interface platform 205A can include a first API gateway 225A. The first API gateway 225A can function as a proxy for application programming interface (API) calls and can help to return an associated response. The first API gateway 225A can help provide other support functions for the service infrastructure 200 such as, for example, authentication functions, etc.

The first application programming interface platform 205A can include one or more APIs such as, for example, a first vehicle API 230A. The vehicle API 230A can include a library and/or parameters for facilitating communications between the first party autonomous vehicles 225A and the backend service(s) 215 of the backend system 210. For example, the first vehicle API 230A can be called by a first party autonomous vehicle 220A and/or another system to help communicate data, messages, etc. to and/or from an autonomous vehicle. The first vehicle API 230A can provide for communicating such information in a secure, bidirectional manner that allows for expanded processing of data offboard a vehicle, analyzing such data in real time, and/or the like.

The first application programming interface platform 205A can include first frontend/backend interface(s) 235A. Each first frontend/backend interface 235A can be associated with a backend service 215 of the backend system 210. The first frontend/backend interface(s) 235A can serve as interface(s) for one client (e.g., an external client such as a first party autonomous vehicle 220A) to provide data to another client (e.g., a backend service 215). In this way, the frontend/backend interface(s) 235A can be external facing edge(s) of the first application programing interface platform 205A that are responsible for providing secure tunnel(s) for first party autonomous vehicles 220A (and/or other systems) to communicate with the backend system 215 (and vice versa) so that a particular backend service can be utilized with a particular first party autonomous vehicle 220A.

In some implementations, the first application programing interface platform 205A can include one or more first adapters 240A, for example, to provide compatibility between one or more first frontend/backend interfaces 235A and one or more of the API(s) associated with the first application programming interface platform 205A (e.g., vehicle API 230A). The first adapter(s) 240A can provide upstream and/or downstream separation between particular infrastructure components, provide or assist with data curation, flow normalization and/or consolidation, etc.

The second application programming interface platform 205B (e.g., a public platform, etc.) can facilitate communication with one or more autonomous vehicles of a third party vehicle provider. As described herein, a third party vehicle provider can be an entity that makes one or more of its autonomous vehicles available to the service entity for the provision of vehicle services. This can include, for example, an individual, an original equipment manufacturer (OEM), a third party vendor, or another entity that puts its autonomous vehicle(s) online with the service platform of the service entity such that the autonomous vehicle(s) can provide vehicle services of the service entity. These autonomous vehicles may be referred to as “third party autonomous vehicles” and are shown in FIG. 2 as third party autonomous vehicles 220B. Even though such autonomous vehicles may not be included in the fleet of autonomous vehicles of the service entity, the service infrastructure 200 (e.g., of the service entity's service platform, etc.) can allow the third party autonomous vehicles 220B to still be utilized to provide the vehicle services offered by the service entity, access the backend system 210, etc.

The second application programming interface platform 205B can allow the service platform to communicate directly or indirectly with autonomous vehicle(s). In some implementations, a third party autonomous vehicle 220B may call an API of, send data/message(s) to, receive data/message(s) from/directly through, etc. the second application programming interface platform 205B.

Additionally, or alternatively, another computing system can serve as an intermediary between the third party autonomous vehicles 220B and the second application programming interface platform 205B (and the service platform associated therewith). For example, the service infrastructure 200 can be associated with and/or in communication with one or more third party vehicle provider computing systems 245, such as a vehicle provider X computing system and a vehicle provider Y computing system. Each third party vehicle provider X, Y can have its own, separate third party autonomous fleet including respective third party autonomous vehicles 220B. The third party vehicle provider computing systems 245 can be distinct and remote from the service infrastructure 200 and provide for management of vehicles associated with that particular third party vehicle provider. As shown in FIG. 2, a third party vehicle provider computing system 245 can include its own backends and/or frontends for communicating with other systems (e.g., third party autonomous vehicle(s) 220B, operations computing system, etc.).

The third party computing system 245 associated with a particular third party autonomous vehicle fleet can serve as the communication intermediary for that fleet. For example, third party autonomous vehicles 220B associated with third party vehicle provider X can communicate with the third party vehicle provider X computing system which can then communicate with the service infrastructure 200 (e.g., to access the available backend services 215) via the second application programming interface platform 205B. Data from the service infrastructure 200 (e.g., the backend services) can be communicated to the vehicle provider X computing system (e.g., via the second application programming interface platform 235B) and then to the third party autonomous vehicles 220B associated with third party vehicle provider X. In another example, third party autonomous vehicles 220B associated with third party vehicle provider Y can communicate with the third party vehicle provider Y computing system which can then communicate with the service infrastructure 200 (e.g., to access the available backend services 215) via the second application programming interface platform 205B. Data from the service infrastructure 200 (e.g., the backend services 215) can be communicated to the third party vehicle provider Y computing system (e.g., via the second application programming interface platform 205B) and then to the third party autonomous vehicles 220B associated with third party vehicle provider Y.

The second application programming interface platform 205B can include a number of components to help facilitate the support, coordination, and management of the third party autonomous vehicles 220B associated with the third party vehicle providers. The second application programming interface platform 205B can provide access to one or more backend services 215 that are available to the third party autonomous vehicles 220B. To help do so, the second application programming interface platform 205B can include a second API gateway 225B. The second API gateway 225B can function as a proxy for application programming interface (API) calls and can help to return an associated response. The second API gateway 225B can help provide other support functions for the service infrastructure 200 such as, for example, authentication functions, etc.

The second application programming interface platform 205B can include one or more APIs such as, for example, a second vehicle API 230B. The second vehicle API 230B can include a library and/or parameters for facilitating communications between the third party autonomous vehicles 220B and the backend service(s) 215 of the backend system 210. For example, the second vehicle API 230B can be called by a third party autonomous vehicle 220B and/or another system (e.g., a third party vehicle provider computing system 245, etc.) to help communicate a data, messages, etc. to and/or from an autonomous vehicle. The second vehicle API 230B can provide for communicating such information in a secure, bidirectional manner.

The second application programming interface platform 205B can include second frontend/backend interface(s) 235B. Each of the second frontend/backend interface(s) 235B can be associated with a backend service 215 of the backend system 210. The second frontend/backend interface(s) 235B can serve as interface(s) for one client (e.g., an external client such as a third party autonomous vehicle 220B, a third party vehicle provider computing system 245) to provide data to another client (e.g., a backend service 215). In this way, the second frontend/backend interface(s) 235B can be external facing edge(s) of the second application programing interface platform 205B that are responsible for providing secure tunnel(s) for third party autonomous vehicles 220B (and/or other intermediary systems) to communicate with the backend system 210 (and vice versa) so that a particular backend service 215 can be utilized. In some implementations, the second application programming interface platform 205B can include one or more second adapters 240B, for example, to provide compatibility between one or more second frontend/backend interfaces 235B and one or more of the API(s) associated with the second application programming interface platform 205B (e.g., vehicle API 230B).

In some implementations, the first party autonomous vehicles 220A can utilize the second application programming interface platform 205B to access/communicate with the service platform/backend service(s) 215. This can allow for greater accessibility and/or back-up communication options for the first party autonomous vehicles 220A.

The backend system 210 can host, store, execute, etc. one or more backend services 215. The backend service(s) 215 can be implemented by system client(s), which can include hardware and/or software that is remote from the autonomous vehicles and that provide a particular service to an autonomous vehicle. The backend service(s) 215 can include a variety of services that help coordinate the provision of vehicle service(s) and support the autonomous vehicles performing/providing those vehicle service(s) and/or the third party vehicle providers.

For example, the backend service(s) 215 can include a matching service that is configured to match an autonomous vehicle and/or an autonomous vehicle fleet with a service request for vehicle services. Based on a match, the matching service can generate and communicate data indicative of a candidate vehicle service assignment (indicative of the requested vehicle service) for one or more autonomous vehicles. In some implementations (e.g., for first party autonomous vehicle(s) 220A), the candidate vehicle service assignment can include a command that a first party autonomous vehicle 220A is required to accept, unless it would be unable to safely or fully perform the vehicle service. In some implementations (e.g., for third party autonomous vehicle(s) 220B), the candidate vehicle service assignment can include a request or offer for one or more autonomous vehicles to provide the vehicle service. This can be sent to one or more third party vehicle provider computing systems 245 and/or to one or more autonomous vehicle(s) 220B. The candidate vehicle service assignment can be accepted or rejected. If accepted, an autonomous vehicle 220A, 220B can be associated with that vehicle service assignment. The vehicle service assignment can include data indicative of the user, a route, an origin location for the vehicle service, a destination service for the vehicle service, service parameters (e.g., time restraints, user accommodations/preferences, etc.) and/or other information.

The backend service(s) 215 can include an itinerary service. The itinerary service can maintain, update, track, etc. a data structure that is indicative of task(s) or candidate task(s) that are (or can be) associated with a particular autonomous vehicle, autonomous vehicle fleet, and/or vehicle provider. The tasks can include, for example, vehicle service assignments for providing vehicle services and/or tasks associated with an activity other than the performance of a vehicle service. For example, the tasks can include: a testing task (e.g., for testing and validating autonomy software, hardware, etc.); a data acquisition task (e.g., acquiring sensor data associated with certain travel ways, etc.); a re-positioning task (e.g., for moving an idle vehicle between vehicle service assignments, etc.); a circling task (e.g., for travelling within the current geographic area in which it is located (e.g., circle the block or neighborhood), etc.); a maintenance task (e.g., for instructing travel to a service depot to receive maintenance, etc.); a re-fueling task; a vehicle assistance task (e.g., where an vehicle travels to assist another vehicle, etc.); a deactivation task (e.g. going offline, etc.); a parking task; and/or other types of tasks.

The itinerary service can maintain an itinerary for an autonomous vehicle, fleet, vehicle provider, etc. The itinerary can serve as a queue for the various tasks. In some implementations, the tasks can be associated with a priority or order for which they are deployed to an autonomous vehicle, fleet, vehicle provider, etc.

In some implementations, the vehicle service assignment can be associated with a multi-modal vehicle service. For example, the user may request and/or be provided a multi-modal user itinerary by which the user is to travel to the user's ultimate destination via two or more types of transportation modalities (e.g., ground based vehicle, aerial vehicle, public transit, etc.). As such, the origin location and/or destination location identified in the vehicle service assignment may include intermediate locations (e.g., transfer points) along the user's multi-modal itinerary.

The backend service(s) 215 can include a deployment service that communicates tasks for an autonomous vehicle to complete. For example, the deployment service can communicate data indicative of a vehicle service assignment and/or another task to an autonomous vehicle (or an intermediary system). The deployment service can communicate such data to an autonomous vehicle (or an intermediary system) based at least in part on the itinerary associated therewith. By way of example, the highest priority task and/or the task that is next in order can be deployed.

The backend services 215 can include a routing service. The routing service can be configured to provide an autonomous vehicle with a route for a vehicle service and/or another task. The route can be based at least in part on factors associated with the geographic area in which the autonomous vehicle is (or will be) travelling (e.g., weather, traffic, events, etc.). Additionally, or alternatively, the route can be based at least in part the autonomy capabilities of the autonomous vehicle (e.g., ability to complete an unprotected left-hand turn, U-turn, etc.). In some implementations, the routing service can be configured to assign, coordinate, monitor, adjust, etc. one or more designated pick-up and/or drop-off zones for the vehicle service(s). The routing service can be available to first party autonomous vehicles 220A. The routing service can be available to third party autonomous vehicles 220B, if permitted/requested by the associated third party vehicle providers.

The backend services 215 can include a rider experience service. The rider experience service can be configured to communicate data to a rider associated with the vehicle service. This can include, for example, upcoming vehicle actions, routes, drop-off zones, user adjustable vehicle conditions (e.g., music, temperature, etc.). Such information can be presented via a display device of an onboard tablet, a user device of the user, etc. through a software application associated with the service entity.

The backend services 215 can include a remote assistance service. The remote assistance service can be configured to provide remote assistance to an autonomous vehicle and/or a user. For example, a remote assistance operator can take over control and/or instruct an autonomous vehicle to traverse/detour around an unexpected obstruction in a travel way (e.g., a fallen tree, etc.). In another example, the remote assistance operator can communicate with the user (e.g., via the onboard tablet, use's phone, etc.) in the event that the user is in need of help.

The backend services 215 can include a simulation/testing system. The simulation/testing service can help facilitate vehicle provider integration with the service platform. For example, simulation/testing service can provide testing environments for vehicle providers to simulate communications and/or the performance of vehicle services using the service infrastructure 200.

The backend services 215 can include one or more other services. This can include, for example, payment services, vehicle rating services, health and maintenance services, software update/deployment services, and/or other services.

In some implementations, one or more backend services 215 that are available to the first party autonomous vehicles 220A (e.g., via the first application programming interface platform 205A) may not be available to the third party autonomous vehicles 220B (e.g., via the second application programming interface platform 205B), and vice versa. For example, a software update/deployment service for the first party autonomous vehicles 220A may not be accessible or suitable for a third party autonomous vehicle 220B that utilizes the onboard autonomy software of a third party vehicle provider (not the service entity). As such, a third party autonomous vehicle 220B and the software update/deployment backend service may not be able to communicate with one another.

In some implementations, the service infrastructure 200 can include a test platform for validating and vetting end-to-end platform functionality, without use of a real vehicle on the ground. For example, the test platform can simulate trips with human drivers and/or support fully simulated trip assignment and/or trip workflow capabilities. For example, the test platform can simulate and monitor data traffic through the service infrastructure 200 to ensure proper functioning. In some implementations, the testing platform can access the simulation/testing backend to help facilitate a test or simulation.

In some implementations, the service infrastructure 200 can utilize a plurality of software development kits (SDKs) that help provide access to the first and second application programming interface platforms 205A, 205B. All (or a portion of) external communication with the platforms can be done via the SDKs. For example, the SDKs can include a first SDK (e.g., private SDK) and a second SDK (e.g., public SDK) and specific endpoints to facilitate communication with the first and second application programming interface platforms 205A, 205B, respectively. In some embodiments, the first party autonomous vehicle(s) 220A (and/or a test platform) can use both the first and second SDKs, whereas the third party autonomous vehicles 220B and/or the third party vehicle provider computing systems 245 can use only the second SDK and associated endpoints. In some implementations, the SDKs can provide a single entry point, which can improve consistency across both the service provider fleet and the third party entity fleet(s). As an example, a second SDK can provide secured access to the second application interface platform 205B and access to capabilities such as vehicle service assignments, routing, and/or the like. The first SDK can be accessed by the first party autonomous vehicles 205A and provide access to capabilities including those available only to the first party autonomous vehicles 205A.

In some implementations, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service entity's services. For example, based on the authentication certificate, a command-line interface can determine which version of the SDK to provide access to. In some implementations, SDKs can be implemented onboard a first or third party autonomous vehicle 220A, 220B and/or a third party vehicle provider computing system 245.

In some implementations, the service infrastructure 200 can facilitate communication between the service platform and one or more other platforms 250 of the service entity/operations computing system. By way of example, the service entity may have (e.g., the operations computing system may include, etc.) one or more other platforms 250 that help indicate what services/vehicles are available to a user, coordinate the provision of vehicle services by human-driven vehicles, that are specifically associated with certain types of services (e.g., delivery services, aerial transport services, etc.). The other platform(s) 250 may communicate with the service platform utilizing the service infrastructure 200 to determine, for example, whether any autonomous vehicles would be available to the user for any potential vehicle services. The other platform(s) can perform any and/or all of the operations and functions of the operations computing system (implementing the service infrastructure 200) as described herein. For example, the other platform(s) 250 can perform any of the filter and/or user/vehicle matching operations and send vehicle recommendations to the service platform (that uses the service infrastructure 200) for communication with the appropriate vehicles and/or vehicle providers. Additionally, or alternatively, the other platform(s) 250 can provide filtering recommendations (e.g., suggested user features, vehicle fleet features, etc.) for another platform to consider.

FIG. 2B depicts an example ecosystem 300 of vehicles according to example embodiments of the present disclosure that may utilize the service infrastructure 200 and the backend services associated therewith (e.g., a remote assistance service, etc.), as seen in FIG. 2A. The ecosystem 300 can include vehicles associated with one or more vehicle providers including, for example, a service entity 305 (e.g., the same service as service entity 185), a third party vehicle provider, an individual (e.g., owning/leasing a human driven vehicle, etc.), etc. A service entity 305 can utilize a plurality of autonomous vehicles including, but not limited to, service entity/first party autonomous vehicles 310 and/or third party autonomous vehicles 315 (e.g., third party vehicle provider X autonomous vehicles, third party vehicle provider Y autonomous vehicles, etc.) to provide vehicle services. An autonomous vehicle 310, 315 can be included in one or more fleets. A fleet can include one or a plurality of autonomous vehicles. The service entity 305 can be associated with a first computing system such as, for example, an operations computing system 320 (e.g., implementing the service infrastructure 200, service platform, same as operations computing system 190A, etc.). The operations computing system 320 of the service entity 305 can help coordinate, support, manage, facilitate, etc. the provision of vehicle service(s) by the autonomous vehicles 310, 315. The service entity 305, autonomous vehicles 310, 315, and operations computing system 320 can include/represent the service entities, autonomous vehicles, and operations computing systems, respectively, discussed with reference to one or more other figures described herein.

Each third party vehicle provider (e.g., vehicle provider X, vehicle provider Y, etc.) can be associated with a respective second computing system such as, for example, a third party computing system 325. The third party computing system 325 can be configured to manage the third party autonomous vehicles 315 (e.g., of the associated fleet, etc.). A third party computing system 325 can manage the vehicle service assignments, other vehicle tasks, dispatch, maintenance, online/offline status, etc. of its associated third party autonomous vehicles 315. Each third party autonomous vehicle 315 (or fleet of third party autonomous vehicles) can communicate with the operations computing system 310 of the service entity 305 directly and/or indirectly via a respective third party computing system 325, as described herein. The third party computing systems 325 can include/represent the third party computing systems discussed with reference to one or more other figures.

In some implementations, the service entity 305 can utilize human driven vehicles 330 for providing vehicle services for the service entity 305. For example, the operations computing system 320 can determine if a vehicle service would be better suited and/or preferable for a human driven vehicle 330 in comparison to an autonomous vehicle 310, 315.

A service entity 305 may have varying levels of control over the vehicle(s) that perform its vehicle services. In some implementations, a vehicle can be included in the service entity's dedicated supply of vehicles. The dedicated supply can include vehicles that are owned, leased, or otherwise exclusively available to the service entity (e.g., for the provision of its vehicle service(s), other tasks, etc.) for at least some period of time. This can include, for example, the first party autonomous vehicles 310. Additionally, or alternatively, this can include a third party autonomous vehicle 315 that is associated with a third party vehicle provider, but that is online only with that service entity (e.g., available to accept vehicle service assignments for only that service entity, etc.) for a certain time period (e.g., a few hours, a day, week, etc.).

In some implementations, a vehicle can be included in the service entity's non-dedicated supply of vehicles. This can include vehicles that are not exclusively available to the service entity 305. For example, a third party autonomous vehicle 315 that is currently online with two different service entities (e.g., concurrently online with a first service entity and a second service entity, etc.) wherein the autonomous vehicle 315 may accept vehicle service assignment(s) from either service entity, may be considered to be part of a non-dedicated supply of vehicles. In some implementations, whether a vehicle is considered to be part of the dedicated supply or the non-dedicated supply can be based, for example, on an agreement between the service entity 305 and a third party vehicle provider associated with that vehicle.

The operations computing system 320 can determine which autonomous vehicles are available for a vehicle service request. In some implementations, the available autonomous vehicles can include those that are currently online with the service entity 305 (e.g., actively engaged, logged in, etc. to a service platform/service entity infrastructure 200, etc.) and are not currently engaged in performance of a vehicle service, performance of a maintenance operation, and/or another task. In some implementations, the operations computing system 320 can determine the availability of an autonomous vehicle 310, 315 based at least in part on data indicating that the autonomous vehicle 310, 315 is online, ready to provide a vehicle service, etc. This can include, for example, data communicated directly from an autonomous vehicle 310, 315 and/or from another computing system (e.g., a third party computing system 325, etc.). In some implementations, the operations computing system 320 can monitor an autonomous vehicle 310, 315 (e.g., its progress along a route, when it comes online, etc.) to help determine whether the autonomous vehicle 310, 315 may be available to service a vehicle service request.

As described herein, each autonomous vehicle 310, 315 that is online with the service entity 305 can be associated with an itinerary. The itinerary can be a data structure (e.g., a list, table, tree, queue, etc.) that is stored and accessible via a backend service of the service infrastructure 200 (e.g., an itinerary service, etc.). The itinerary can include a sequence of tasks for the autonomous vehicle. In some implementations, the operations computing system 320 can determine that a vehicle is (or is not) available to provide a vehicle service based at least in part on an associated itinerary.

The operations computing system 320 of the service entity 305 can obtain data indicative of one or more operational capabilities of an autonomous vehicle 310, 315. The operational capabilities can describe the autonomy capabilities 335 of the autonomous vehicles 310, 315 (and/or its associated fleet), geographic data 340 associated with autonomous vehicles 310, 315 (and/or its associated fleet), and/or other information. The autonomy capabilities 335 can be indicative of the capabilities of the autonomous vehicle to autonomously navigate/operate (e.g., while in a fully autonomous mode), the restrictions of an autonomous vehicle 310, 315, scenarios in which the autonomous vehicle 310, 315 can/cannot operate, and/or other information descriptive of how an autonomous vehicle 310, 315 can or cannot autonomously operate. For instance, the autonomy capabilities 335 can indicate one or more vehicle motion maneuvers that an autonomous vehicle 310, 315 can or cannot autonomously perform (e.g., without human input, while in a fully autonomous mode). By way of example, the autonomy capabilities 335 can indicate whether the autonomous vehicle(s) 310, 315 in a particular fleet can perform a U-turn and/or whether the autonomous vehicle(s) 310, 315 are restricted from performing an unprotected left turn. In another example, the autonomy capabilities 335 can indicate that an autonomous vehicle 310, 315 is capable of operating in a respective traffic area (e.g., a high traffic area such as an urban setting, a minimal traffic area such as a rural setting, etc.) and/or one or a plurality of geographic fences/boundaries identifying where the autonomous vehicle can travel (e.g., based on the map data available to the autonomous vehicle, vehicle provider preferences, etc.). The geographic data 340 can be indicative of the past, present, and/or future location(s) of an autonomous vehicle 310, 315 (e.g., when/where it is available to provide a vehicle service, to be used for re-positioning, etc.). Such information can be utilized to customize the remote assistance for an autonomous vehicle to appropriately match its capabilities and/or the areas in which the vehicle can operate.

FIG. 2C depicts an example system architecture 400 according to example embodiments of the present disclosure. The diagram of the system architecture 400 illustrates an example data flow between the back-end services provided via an operations computing system (e.g., the service infrastructure 200) and a vehicle computing system 405 (e.g., of first or third party autonomous vehicle, etc.). The vehicle computing system 405 can be the same as, correspond to, represent, include one or more components of, etc. the vehicle computing systems described herein (e.g., vehicle computing system 110, etc.). As described herein, one or more of the communications can be communicated through/via an intermediate system such as, for example, a third party computing system (e.g., associated with the autonomous vehicle). One of the back-end services provided via the operations computing system (e.g., the service platform) can include a remote assistance service. The remote assistance service can be implemented by a remote assistance system 410 configured to coordinate and provide remote assistance to an autonomous vehicle that is experiencing a remote assistance event.

A remote assistance event can include a situation for which the autonomous vehicle does not have sufficient confidence to (or is unable to) address using its autonomy and/or other onboard systems. In some implementations, a remote assistance event can be associated with an external environment of the autonomous vehicle. For example, a remote assistance event can include an unexpected fallen tree that is blocking travel way lanes in the direction that the autonomous vehicle is travelling. The autonomous vehicle may be programmed to avoid travel in an oncoming lane (and/or reversing in the current lane) without overriding instructions. Thus, the vehicle computing system 405 may have low confidence, high uncertainty etc. in its ability to motion plan around the object, which would require travelling in an oncoming lane (and/or reversing in the current lane).

In some implementations, a remote assistance event can be associated with an interior of the autonomous vehicle. For example, the autonomous vehicle can include interior sensors (e.g., in-cabin cameras, etc.) that are configured to acquire sensor data indicative of the interior of the vehicle and the objects included therein. A remote assistance event associated with the interior of the autonomous vehicle can include, for example, a passenger becoming ill, a damaging event in the vehicle's cabin (e.g., fire, leak, etc.), a conflict between passengers, etc.

The remote assistance system 410 can coordinate and/or perform the evaluation of the vehicle's circumstances and instruct the autonomous vehicle to take an action to address, overcome, bypass, etc. the remote assistance event. In some implementations, the remote assistance system 410 can automatically evaluate the vehicle's circumstances for example, by processing the vehicle's sensor and/or other telemetry data utilizing machine-learned model(s) to determine a recommended action for overcoming the condition associated with the remote assistance event. A remote assistance event analyzer 415 can be configured to automatically determine a recommended action for the autonomous vehicle (e.g., utilized trained machine-learned model(s), etc.), as further described herein. Additionally, or alternatively, a remote assistance operator 420 can be assigned to evaluate the vehicle's circumstances (e.g., via a user interface, etc.) and determine an appropriate action for the autonomous vehicle to safely address the remote assistance event.

The technology described herein can help improve the efficiency of the remote assistance system 410, remote assistance operator 420, and the autonomous vehicle receiving the remote assistance. The systems and methods described herein can do so by providing improved contextual awareness with respect to the autonomous vehicle and a remote assistance event.

The vehicle computing system 405 can obtain data 425 associated with the autonomous vehicle. The data 425 associated with the autonomous vehicle can include at least one of: data 430A associated with a geographic area in which the autonomous vehicle is or will be located (e.g., planned to be, predicted to be, routed to be, etc.), interior sensor data 430C associated with an interior of the autonomous vehicle, and/or external sensor data 430B associated with a surrounding environment of the autonomous vehicle. The interior sensor data 430C associated with the interior of the autonomous vehicle can include, for example, image data acquired by camera(s) and/or other sensor(s) (e.g., motion sensors, heat sensors, weight sensors, etc.) located within the interior of autonomous vehicle. The external sensor data 430B can include, for example, LIDAR, camera, RADAR, and/or other sensor data providing a field of view of the exterior environment surrounding the autonomous vehicle. The external sensor data 430C can be indicative of the travel way(s) and/or object(s) included in the environment surrounding the autonomous vehicle. The data 425 associated with an autonomous vehicle can also, or alternatively, include data that the autonomous vehicle receives from one or more other vehicles. For example, another autonomous vehicle may directly or indirectly provide a communication to the autonomous vehicle indicating that an area may have a potential remote assistance event and/or does in fact have a remote assistance event (e.g., lane blockages, etc.).

The data 430A associated with a geographic area in which the autonomous vehicle is or will be located can include map data and/or other types of data indicative of one or more areas that have historically and/or are predicted to include remote assistance event(s). This can include, for instance, area(s) with obstacles, roadwork, poor travelling condition(s), certain weather, etc. that may be considered remote assistance events for an autonomous vehicle. The identification of these events may arise from one or more other vehicles (e.g., human-driven, autonomous vehicles, drones, etc.). For example, the other vehicle(s) can capture sensor data associated with previous remote assistance events within a particular area and the remote assistance system 410 (and/or another system) can maintain a database of the areas and their historical remote assistance events. Map data can be encoded to indicate which area(s) may trigger a remote assistance event such that the autonomous vehicle can pre-emptively identify potential remote assistance events.

The vehicle computing system 405 can detect a potential remote assistance event 435 based at least in part on the data 425 associated with the autonomous vehicle. A potential remote assistance event 435 can be detected when the vehicle computing system 405 determines that a remote assistance event may occur. The detection can be based at least in part on the vehicle computing system's confidence that a remote assistance event will occur. The vehicle computing system 405 can determine a confidence 440 associated with the potential remote assistance event 435. By way of example, the vehicle computing system 405 can determine that it is 30% confident that a potential remote assistance event 435 may occur in light of its initial perception of a fallen tree is blocking all lanes in the vehicle's direction of travel and its determination that the vehicle may not be able to traverse around the fallen tree without exiting the lane(s) associated with its direction of travel. In another example, the vehicle computing system 405 can determine that it is 75% confident that a potential remote assistance event may occur because the autonomous vehicle is within a certain distance from entering an area previously associated with remote assistance event(s) (e.g., as indicated in the encoded map data, etc.) and the vehicle's currently planned route and/or motion trajectory appears to be leading the vehicle to that area.

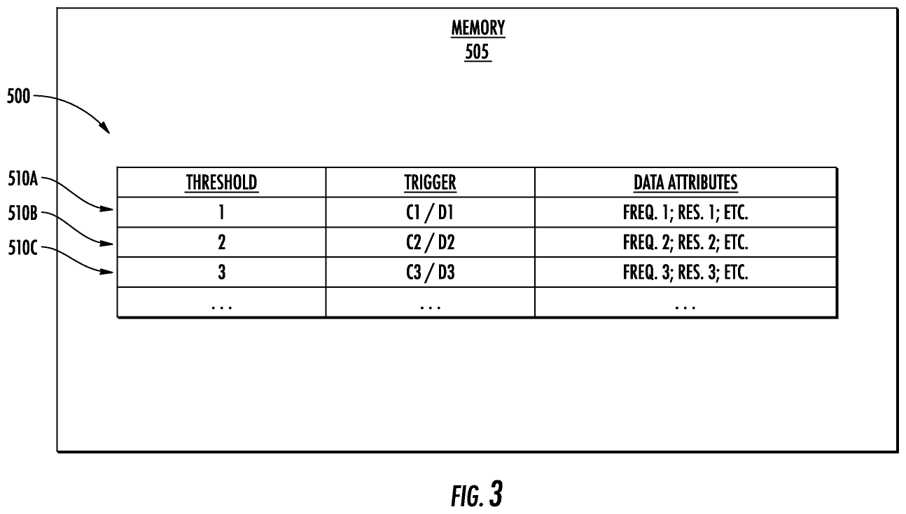

In some implementations, the vehicle computing system 405 can detect the potential remote assistance event 435 based at least in part on a comparison of the confidence 440 to a threshold. For instance, with reference to FIG. 3, the vehicle computing system 405 can include a data structure 500 (stored within one or more memories 505) defining one or more thresholds 510A-C (e.g., confidence thresholds, distance thresholds, etc.) that may trigger a detection of a potential remote assistance event 435. The threshold(s) may include a first threshold 510A indicative of a first confidence level C1 (e.g., 30%, 40%, 50%, etc.) and/or a first distance threshold D1 (e.g., 0.5, 1, 2, 3 miles, etc. from an area with a history of and/or predicted to have remote assistance event(s)). The vehicle computing system 405 can detect a potential remote assistance event 435 based at least in part on a comparison of the confidence 440 to the first threshold 510A. A confidence 440 in the occurrence of the potential remote assistance event 435 at or above this first threshold 510A may result in the vehicle computing system 405 detecting a trigger to initiate a preliminary remote assistance action, as further described herein. Additionally or alternatively, the vehicle computing system 405 may detect a potential remote assistance event 435 in the event the autonomous vehicle is within that distance D1 (and a current route/motion plan would potentially lead to an area associated with the remote assistance event).

The data structure 500 can also, or alternatively, include one or more additional thresholds 510B-C. This can include a second threshold 510B associated with a second confidence level C2 and/or distance D2. This can include a third threshold 510C associated with a third confidence level C3 and/or distance D3. The third confidence level C3 can include a higher confidence level than the second confidence level C2, which can include a higher confidence level than the first confidence level C1. The third distance D3 can include a shorter distance than the second distance D2, which can include a shorter distance than the first distance D1.

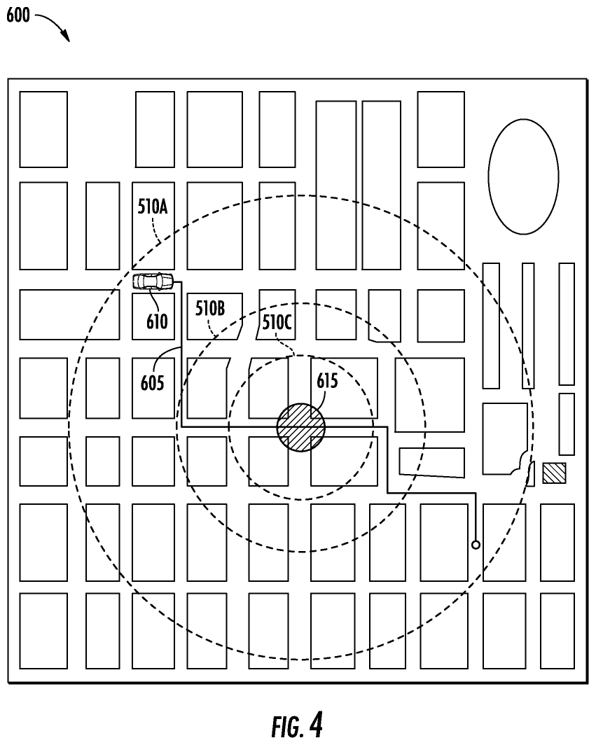

FIG. 4 depicts an example of a geographic area 600 according to example embodiments of the present disclosure. FIG. 4 presents a graphical representation of the thresholds 510A-C. The radial nature of the thresholds is shown for example illustrative purposes only and is not meant to be limiting. The first threshold 510A can be associated with a first confidence level C1 and/or a distance D1. The first confidence level C1 can be indicative of a confidence level that a potential remote assistance event 435 will occur, for example, along a route 605 of the autonomous vehicle 610 such as, for example, in area 615. The first distance D1 can be indicative of a certain distance (e.g., radial distance, direct as-bird-flies distance, route/driving distance, etc.) from an area 615 that has a history of remote assistance events. The second threshold 510B can be associated with a second confidence level C2 that is higher than the first confidence level C1 (e.g., because it is closer to and/or has a better field of view of the potential remote assistance event, etc.) and/or a second distance D2 that is less than the first distance D1 (e.g., closer to area 615). The third threshold 510C can be associated with a third confidence level C2 that is higher than the second confidence level C2 (e.g., because it is closer to and/or has a better field of view of the potential remote assistance event, etc.) and/or a third distance D3 that is less than the second distance D2 (e.g., closer to area 615).

Returning to FIG. 2C, the vehicle computing system 405 can initiate a preliminary remote assistance action 445 based at least in part on the detected potential remote assistance event 435. For example, the vehicle computing system 405 can initiate a preliminary remote assistance action 445 in response to the confidence 440 in the occurrence of the potential remote assistance event 435 exceeding the first threshold 510A. The preliminary remote assistance action 445 can include an action that the autonomous vehicle performs in anticipation of a remote assistance event and prior to sending a remote assistance request. The preliminary remote assistance action 445 can include a preemptive buffer of sensor data acquired by the autonomous vehicle prior to communicating a request for remote assistance. For instance, the preliminary remote assistance action 445 can include at least one of transmitting sensor data acquired by the autonomous vehicle (e.g., prior to the remote assistance request, etc.) to a remote computing system and/or storing the sensor data onboard the autonomous vehicle.

The vehicle computing system 405 can select the type of preliminary remote assistance action 445 for the autonomous vehicle to perform. This can include a first type of preliminary remote assistance action 445 associated with the preemptive storage of sensor data 450 onboard the autonomous vehicle. The sensor data 450 can be stored in an onboard memory 455 such as, for example, a buffer onboard the autonomous vehicle. The sensor data 450 can may be referred to as “past sensor data” because is it required before an actual remote assistant event being identified and/or a remote assistance request being communicated by the vehicle computing system 405. Additionally, or alternatively, the vehicle computing system 405 can select a second type of preliminary remote assistance action 445 associated with the preemptive storage of sensor data offboard the autonomous vehicle. This preliminary remote assistance action 445 can include transmitting the sensor data 450 acquired by the autonomous vehicle to a remote computing system. The sensor data 450 can be stored by the remote computing system in an offboard memory 460 such as, for example, a buffer that is remote from the vehicle computing system 405/autonomous vehicle. The offboard memory 460 can be included in and/or accessible by the remote assistance system 410. As described herein, the sensor data 450 (stored onboard and/or offboard the autonomous vehicle) can include sensor data acquired by the autonomous vehicle prior to a remote assistance request by the vehicle.

The vehicle computing system 405 can select the type of preliminary remote assistance action 445 based at least in part on the circumstances of the autonomous vehicle. In some implementations, the vehicle computing system 405 can select the preliminary remote assistance action 445 based at least in part on a confidence 440 associated with the potential remote assistance event 435. For example, the vehicle computing system 405 may have a first confidence (e.g., a 35% confidence, etc.) that a potential remote assistance event 435 will occur. This can arise, for example, based on a perception of a potentially fallen tree in the travel way in the distance. This confidence level may exceed a first threshold 510A (e.g., a 30% confidence threshold). Based at least in part on the first confidence associated with the potential remote assistance event 435 exceeding the first threshold 510A the vehicle computing system 405 can select (and initiate) the first type of preliminary remote assistance. For example, the vehicle computing system can begin to store sensor data 450 in a memory 455 onboard the autonomous vehicle (e.g., a buffer onboard the autonomous vehicle).

As the confidence 440 in the occurrence of the potential remote assistance event 435 increases the vehicle computing system 405 can select another type of preliminary remote assistance action 445. For instance, as the autonomous vehicle gets closer to, has a better view of, etc. the potential remote assistance event 435 (e.g., the fallen tree, etc.) the vehicle computing system 405 can become more confident that the potential remote assistance event 435 will occur. For example, as the autonomous vehicle approaches the fallen tree it may become 80% confident that a remote assistance event will occur because the vehicle computing system 405 is more confident (e.g., due to its better view) that the fallen tree is blocking all lanes in the autonomous vehicle's current direction of travel and the vehicle will need remote assistance to move around the tree. The vehicle computing system 405 can determine this updated confidence and compare it to a second threshold 510B (e.g., a 75% confidence threshold). The vehicle computing system 405 can determine that the updated confidence has met or exceeded the second threshold 510B based at least in part on this comparison. The vehicle computing system 405 can select, switch to, initiate, etc. the second type of preliminary remote assistance action 445 based on the updated confidence meeting/exceeding the second threshold 510B. For example, the vehicle computing system 405 can begin to transmit sensor data 450 to a remote computing system (e.g., a remote assistance system 410, etc.) for storage remote from the autonomous vehicle. The remote computing system can obtain this sensor data 450 (e.g., past sensor data acquired before the remote assistance request, etc.) and store the sensor data 450 in a memory 460 remote from the autonomous vehicle (e.g., in a buffer and/or other storage medium, etc.).

In some implementations, the vehicle computing system 405 can select a type of preliminary remote assistance action 445 based at least in part on other circumstances of the autonomous vehicle. For instance, the vehicle computing system 405 can select the type of preliminary remote assistance action 445 based at least in part on one or more communicability factors. The communicability factors 465 could include the signal strength/connectivity between the autonomous vehicle and the remote computing system, the bandwidth, network availability, etc. In the event that a certain communication network (e.g., LTE, etc.) is not available and/or the available telecommunication bandwidth is low (e.g., because the vehicle is sending other data, etc.), the vehicle computing system 405 can select the first type of preliminary assistance action 445 and store data onboard the autonomous vehicle in the onboard memory 455 (e.g., in an onboard buffer, etc.). The vehicle computing system 405 can switch to the second type of preliminary remote assistance action 445 in the event communicability factor(s) change/improve. For example, in the event that the available networks/telecommunication bandwidth increases, the vehicle computing system 405 can transmit the sensor data 450 to the remote computing system for storage offboard the autonomous vehicle.

Initiating the preliminary remote assistance action can include determining data attribute(s) 470 for the sensor data 450 to be stored onboard and/or offboard of the autonomous vehicle. For instance, the vehicle computing system 405 can determine one or more data attributes 470 for the sensor data 450 to be stored in accordance with the selected preliminary remote assistance action 445. The data attribute(s) 470 can include at least one of a frequency of the sensor data (e.g., a frame rate, sampling rate, etc.), quality of the sensor data (e.g., sharpness, luminosity, consistency, completeness, etc.), a resolution of the sensor data, and/or other sensor data metrics.

In some implementations, the data attribute(s) 470 can be determined based at least in part on an object (e.g., its static/dynamic type, classification, etc.) associated with the potential remote assistance event 435. By way of example, the vehicle computing system 405 can detect that a static object such as, for example, a fallen tree is within the travel way of the autonomous vehicle. Because the object is static, the motion of the object over time may be less important to the remote assistance system 410 and/or operator 420. The vehicle computing system 405 can determine that the sensor data 450 (buffered onboard and/or offboard the vehicle) should be stored with higher resolution but at lower frame rate. The vehicle computing system 405 may do so because the motion of the fallen tree leading up to its location within the travel way may be of lower importance in determining an appropriate action for the autonomous vehicle than identifying the tree's location with greater accuracy (e.g., using higher resolution, etc.). In another example, the vehicle computing system 405 can detect that an object/actor, which is typically dynamic (e.g., a vehicle), is blocking the travel way of the autonomous vehicle. Because the object is typically dynamic, the motion of the object over time may be of higher importance to the remote assistance system 410 and/or the remote assistance operator 420. For example, it may be important for the remote assistance system 410 and/or the remote assistance operator 420 to determine whether the blocking vehicle is temporarily parked (e.g., because an operator of the vehicle left to deliver an item, etc.) or whether it appears that the vehicle will be located within the temporary travel way for an extended time period (e.g., because it is broken down, etc.). The vehicle computing system 405 can determine that the buffered sensor data 450 associated with this potential remote assistance event 435 should be stored with lower resolution but at a higher frame rate because the motion of the object (e.g., the blocking vehicle, etc.) leading up to its location within the travel way may be of higher importance when determining an appropriate action for the autonomous vehicle. In this way, the frequency of the sensor data (and/or other data attribute(s)) can be associated with the type of an object associated with the potential remote assistance event.

In some implementations, the data attribute(s) 470 of the sensor data 450 to be preemptively stored can be based at least in part on other circumstance(s) associated with the autonomous vehicle. For instance, the vehicle computing system can determine one or more data attributes 470 for the sensor data 450 based at least in part on the vehicle computing system's confidence 440 that a potential remote assistance event 435 will occur. One or more of the data attributes 470 can be adjusted as confidence 440 in the occurrence of the potential remote assistance event 435 increases, decreases, etc. For example, the vehicle computing system 405 can determine one or more data attributes 470 for the sensor data 450 based at least in part on a first threshold 510A (e.g., a first confidence threshold). When the vehicle's confidence level meets or exceeds the first threshold 510A, the vehicle computing system 405 can determine that the vehicle will start storing and/or transmitting sensor data 450 at a first frame rate FREQ1 (e.g., 1 frame per second, etc.). As the confidence 440 in the occurrence of the remote assistance event 435 increases, the vehicle computing system 405 can adjust the data attribute(s) 470 of the sensor data 450 stored/transmitted prior to a remote assistance request. For example, the vehicle computing system 405 can update the one or more data attributes 470 based at least in part on a second threshold 510B (e.g., a second confidence threshold). When the confidence 440 meets or exceeds the second threshold 510B, the vehicle computing system 405 can determine that it will start storing and/or transmitting the sensor data 450 at a second frame rate FREQ2 (e.g., 10 frames per second, etc.). In some implementations, the first and second frame rates FREQ1, FREQ2 can be defined in the data structure 500 (e.g., shown in FIG. 3). This can allow the preemptively stored sensor data 450 to be adapted as the likelihood of a potential remote assistance event 435 increases.

The vehicle computing system 405 can initiate the preliminary remote assistance action 445 based at least in part on the one or more data attributes 470. For instance, the vehicle computing system 405 can initiate the preliminary remote assistance action 445 by performing the selected type of preliminary remote assistance action 445 with the determined data attribute(s) 470. For example, the vehicle computing system 405 can transmit sensor data 450 acquired by the autonomous vehicle to a remote computing system based at least in part on the one or more data attributes 470 and/or store the sensor data 450 onboard the autonomous vehicle based at least in part on the one or more data attributes 470. This can include transmitting offboard and/or storing onboard the sensor data 450 (acquired prior to sending remote assistance request) with a certain frequency, quality, resolution, etc.

After the initiation of the preliminary remote assistance action 445, the vehicle computing system 405 can communicate a request 475 for remote assistance of the autonomous vehicle. For instance, the vehicle computing system 405 can communicate a remote assistance request 475 when the potential remote assistance event 435 occurs/is presently affecting the autonomous vehicle. The autonomous vehicle can be uncertain and/or lacks sufficient confidence to handle the potential remote assistance event 435. This can be due to a lack of confidence in the vehicle computing system's perception/motion prediction of an object associated with the remote assistance event and/or a lack of confidence in the vehicle's motion plan to traverse the object. By way of example, the vehicle computing system 405 can communicate a remote assistance request 475 when the autonomous vehicle has reached an area (e.g., area 615, etc.) in which a fallen tree is blocking all lanes of travel in the direction of the autonomous vehicle. The vehicle computing system 405 may lack confidence and/or determine a high cost (e.g., due to motion constraints, etc.) associated with planning the motion of the vehicle to travel in an oncoming lane to move around the tree. As such, the autonomous vehicle can communicate a remote assistance request 475 requesting that the remote assistance system 410 and/or the remote assistance operator 420 provide guidance on the situation. In some implementations, the autonomous vehicle can remain stopped while the request is pending.

The remote assistance request 475 can trigger a release of the preemptively stored sensor data 450 for use by the remote assistance system 410 and/or the remote assistance operator 420 in addressing the remote assistance event. For instance, the vehicle computing system 405 can release the sensor data 450 stored onboard the autonomous vehicle. The vehicle computing system 405 can initiate the transmission of the sensor data 450 stored onboard the autonomous vehicle to the remote computing system. In some implementations, the autonomous vehicle can begin to communicate this sensor data 450 at or near the time the remote assistance request is sent. For example, the autonomous vehicle can provide a data package with the remote assistance request 475. The data package can include the sensor data 450 stored onboard the autonomous vehicle in accordance with the preliminary remote assistance action 445. When the preliminary remote assistance action 445 includes transmitting sensor data 450 acquired by the autonomous vehicle to a remote computing system, the sensor data 450 can be stored (e.g., by and/or accessible by the remote computing system, etc.) in an offboard memory 460 (e.g., a buffer, etc.) remote from the autonomous vehicle. This sensor data 450 can be provided from and/or otherwise accessed from the offboard memory 460 in response to the remote assistance request 475 (e.g., by the remote assistance system 410, by another system for transmission to the remote assistance system, etc.).

The sensor data 450 stored onboard and/or offboard the autonomous vehicle can be transmitted to and/or accessed by the remote computing system 410 prior to assignment of the remote assistance request 475 to a remote assistance operator 420. This can allow the remote assistance system 410 to begin generating composites, timelines, user interfaces, etc. (as further described herein) for the remote assistance operator 420 assigned to the remote assistance event. In some implementations, sensor data 450 stored onboard and/or offboard the autonomous vehicle can be transmitted to and/or accessed by the remote computing system 410 after assignment of the remote assistance request 475 to a remote assistance operator 420.

In some implementations, communication of the remote assistance request 475 can trigger the transmission of other data from the autonomous vehicle. For example, the vehicle computing system 405 can initiate a live stream of current sensor data 480 of the autonomous vehicle to the remote computing system. The current sensor data 480 can include data that the autonomous vehicle is presently acquiring while presently experiencing the remote assistance event (e.g., while it is stopped for the fallen tree, etc.).

The past sensor data 450 that had been preemptively stored onboard the autonomous vehicle and the current sensor data 480 can be communicated via two different communication streams. The autonomous vehicle can communicate with a remote computing system via one or more networks using one or more protocols (e.g., webRTC protocol, etc.). By way of example, the past sensor data 450 and the current sensor data 480 can be provided via LTE network(s) using two different webRTC streams. The communication streams can be adjusted based at least in part on the data transmissions to help effectively offboard the two different types of sensor data 450, 480. For example, the vehicle computing system 405 can degrade (e.g., lower bandwidth, adjust associated data attribute(s), etc.) the live sensor stream used for transmitting the current sensor data 480 while the past sensor data 450 (e.g., buffered onboard the vehicle, etc.) is concurrently transmitted. When transmission of the past sensor data 450 is complete, the vehicle computing system 405 can upgrade the live sensor stream of the current sensor data 480 (e.g., to increase the bandwidth, speed, etc. in that communication stream).

In another example, the vehicle computing system 405 can prioritize the transmission of the current sensor data 480 over the past sensor data 450. This can allow the current sensor data 480 to be analyzed and/or viewed by the remote assistance operator 420 in a faster manner. For instance, the vehicle computing system 405 can degrade (e.g., lower bandwidth, adjust associated data attribute(s), etc.) the communication channel/stream used for transmitting the past sensor data 450 while the current sensor data 480 is concurrently transmitted. When transmission of the current sensor data 480 is complete, the vehicle computing system 405 can upgrade the communication channel/stream of the past sensor data 450 (e.g., to increase the bandwidth, speed, etc. in that communication stream).

The remote assistance system 410 can obtain a remote assistance request 475 for remote assistance of the autonomous vehicle and provide/coordinate such remote assistance. For instance, the remote assistance system 410 can obtain past sensor data 450 acquired by the autonomous vehicle. As described herein, this can include the past sensor data 450 that was stored onboard the autonomous vehicle and/or remote from the autonomous vehicle based at least in part on the detection of the potential remote assistance event 435 (e.g., before communicating the remote assistance request 475, etc.). The remote assistance system 410 can obtain the live stream of current sensor data 480 acquired by the autonomous vehicle (e.g., after/while communicating the remote assistance request, etc.). The remote assistance system 410 can generate a composite sensor data set 485 based at least in part on the past sensor data 450 acquired by the autonomous vehicle and the live stream of the current sensor data 480 acquired by the autonomous vehicle. For example, the remote assistance system 410 can process the past and current sensor data 450, 480 to determine timestamp(s) associated with frames of sensor data (e.g., camera data, etc.). The remote assistance system 410 can stitch the frames together in a sequential order to create the composite sensor data 485. The past sensor data 450 can appear prior to the current sensor data 480 because the timestamp(s) associated with the frames of the past sensor data 450 will be older than those of the current sensor data 480.

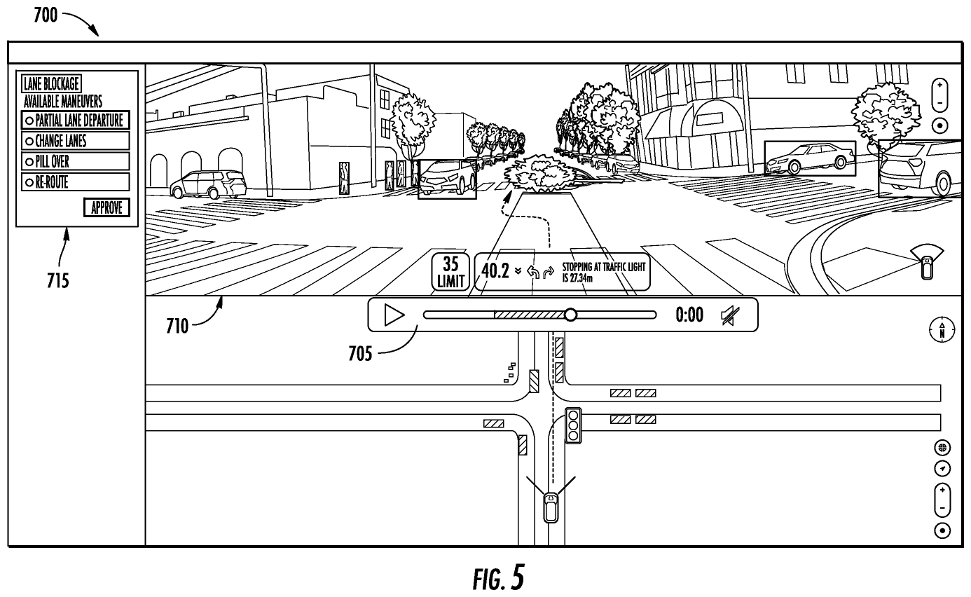

Remote assistance command(s) 490 for the autonomous vehicle can be determined based at least in part on the composite sensor data 485. For instance, as shown in FIG. 5, the remote assistance system 410 can generate a user interface 700, shown in FIG. 5, based at least in part on the composite sensor data 485. The user interface 700 can be presented via a display device of a user computing device associated with the remote assistance system 410. The user interface 700 can allow for viewing/playback of the past sensor data 450 acquired by the autonomous vehicle and/or viewing of the current sensor data 480 acquired by the autonomous vehicle. For instance, the user interface 700 can include a user interface element 705 (e.g., a playback bar, slider, time scale, etc.) that allows a remote assistance operator 420 to provide user input to view the composite sensor data 485 at different points in time.

The user interface 700 can include a rendering of the composite sensor data 485. For example, a viewing section 710 of the user interface 700 can include a rendered field of view of the autonomous vehicle's sensors as provided by the past/buffered sensor data 450 and the current sensor data 480. The rendered view can depict the external environment of the autonomous vehicle and the static/dynamic objects within this environment. This can include a rendering of an object (e.g., fallen tree, vehicle, etc.) contributing to the remote assistance request 475. Additionally, or alternatively, the rendered view can depict the interior of the autonomous vehicle and the objects within the interior, including any object(s) that may be contributing to the remote assistance request 475 (e.g., smoke, passengers in conflict, etc.). A remote assistance operator 420 can provide user input to the user interface element 705 to manipulate the timeframe of the composite sensor data 485 and the rendered view can depict the sensor data acquired by the vehicle at the user-selected time in the timeframe. Thus, the remote assistance operator 420 can gain valuable context of the events associated with the remote assistance event leading up to the current time.

In some implementations, the user interface 700 can include “backwards buffering” of the vehicle's sensor data. For instance, the current sensor data 480 can be acquired by the remote assistance system 410 and rendered in the user interface 700 before the past sensor data 450. This can allow the remote assistance operator 420 to more immediately review the current circumstances of the autonomous vehicle. The remote assistance system 410 can acquire the past sensor data 450 and begin to generate the composite sensor data 485. The remote assistance system 410 can make viewing of the past sensor data 450 available (e.g., after the current sensor data 480, etc.). For example, the remote assistance system 410 can begin buffering the past sensor data 450 so that the operator 420 can rewind the rendering of the composite sensor 485 so that the remote assistance operator 420 can view the circumstance of the autonomous vehicle at previous time(s) (e.g., leading up to the remote assistance event). The ability to rewind the rendered sensor data can become available after an initial rendering of the current sensor data 480. In this way, the remote assistance system 410 can provide backward buffering of the vehicle's sensor data in the user interface 700 for previous timeframes (e.g., as shown in FIG. 5).

In some implementation, the user interface 700 can include one or more user interface elements 715 associated with actions that can be performed by the autonomous vehicle to overcome/address the remote assistance event. For example, the user interface 700 may include a button that indicates the autonomous vehicle is to perform a partial lane departure to travel around a fallen tree (into an oncoming lane). A remote assistance operator 420 may select this vehicle action in the event that this movement by the autonomous vehicle would not place the vehicle, its passengers, and/or objects in the environment in danger. In another example, the user interface 700 may include a button that indicates the vehicle is to pullover and/or queue behind an object (e.g., tree, vehicle, etc.) that is currently blocking the travel lane. A remote assistance operator 420 may select such a vehicle action, for example, in the event the blockage may be temporary. By way of example, remote assistance operator 420 may select such a vehicle action in the event that the past sensor data 450 shows that a driver of a blocking vehicle appears to have temporarily left the vehicle (e.g., to make a delivery, etc.). The current sensor data 480 may indicate that the driver appears to be returning to the vehicle. As such, the remote assistance operator 420 may determine that the best course of action includes the autonomous vehicle waiting behind the parking vehicle until the parked vehicle begins to move again. The remote assistance system 410 can obtain data indicative of a remote assistance command 490 based at least in part on user input associated with the user interface 700 (e.g., interaction with a particular user interface element, etc.). The remote assistance command 490 can be indicative of a vehicle action for the autonomous vehicle to perform. This can be, for example, the vehicle action associated with the user interface element selected by the remote assistance operator 420.

In some implementations, user interface elements 715 associated with actions that can be performed by the autonomous vehicle can be filtered based at least in part on the past sensor data 450. For instance, the remote assistance system 410 can evaluate the past sensor data 450 (and/or the composite sensor data 485) and determine that certain action(s) may be not appropriate and/or worthwhile for consideration. By way of example, the remote assistance system 410 can evaluate the past sensor data 450 to identify that a fallen tree is blocking all lanes of travel in the direction of the autonomous vehicle. In response, the remote assistance system 410 can filter out (and not display) an override “disregard/proceed in lane” action for the remote assistance operator 420 to select to instruct the autonomous vehicle to proceed as if the detected tree was an erroneous/false positive detection.

Returning to FIG. 2C, in some implementations, the remote assistance system 410 can determine a remote assistance command 490 without input from a remote assistance operator 420. For example, the remote assistance system 410 can include one or more machine-learned models (e.g., neural networks, etc.) configured to process the composite sensor data 485 to determine the cause of the remote assistance event (e.g., detect the fallen tree, etc.). For example, the model(s) can be trained to evaluate the past/current sensor data 450, 480 (and map data) to identify that a fallen tree is blocking potential lane(s) of travel for the autonomous vehicle. The remote assistance system 410 can include one or more machine-learned models configured to determine a recommended vehicle action based at least in part on the cause of the remote assistance event (e.g., detect the fallen tree, etc.). For example, the model(s) can be trained (e.g., using supervised learned techniques of past remote assistance event/command pairs, etc.) to evaluate the past/current sensor data 450, 480 (and map data) to identify that the autonomous vehicle could traverse around the fallen tree by travelling in an oncoming lane and that the autonomous vehicle can do so without high cost/increased risk of danger (e.g., because there is no oncoming traffic, etc.). In some implementations, a remote assistance operator 420 can confirm the automatically determined/recommended action(s) (e.g., via user input to a user interface presenting such recommended action(s), etc.).

The remote assistance system 410 can communicate the remote assistance command 490 to the autonomous vehicle. The remote assistance command 490 can include data indicative of a vehicle action selected by a remote assistance operator 420 and/or the remote assistance system 410. The remote assistance command 490 can be communicated (e.g., via the service platform, etc.) directly and/or indirectly to the autonomous vehicle. In some implementations, the remote assistance command 490 can be indicative of a vehicle action instructing the autonomous vehicle to change to a manual operating mode whereby the remote assistance operator 420 can manually control the motion of the autonomous vehicle from a remote location.

The vehicle computing system 405 can obtain the remote assistance command indicative of the vehicle action for the autonomous vehicle and initiate the vehicle action for the autonomous vehicle. For instance, the vehicle computing system 405 can initiate a motion control of the autonomous vehicle in accordance with the vehicle action. This can include, for example, instructing the vehicle's autonomy system to generate a motion plan to travel around the fallen tree by temporarily travelling in an oncoming lane. These instructions can include an override of motion constraint(s) generally applied to the vehicle's motion planning in order to allow the autonomous vehicle to generate such a motion plan. In some implementations, the vehicle computing system 405 can bypass the autonomy system to implement the vehicle action. For example, the remote assistance system can generate a motion plan and/or an ingestible vehicle trajectory and communicate such information with the remote assistance command 490. The generated motion plan/trajectory can be provided to the vehicle's interface for implementation by the vehicle's control system(s) (e.g., steering, braking, acceleration, etc.), bypassing the vehicle's autonomy system. In some implementations, the vehicle computing system 405 can implement an operating mode change in response to a vehicle action indicative of such a change. This can allow, for example, a remote assistance operator 420 to manually (and remotely) control the motion of the autonomous vehicle.

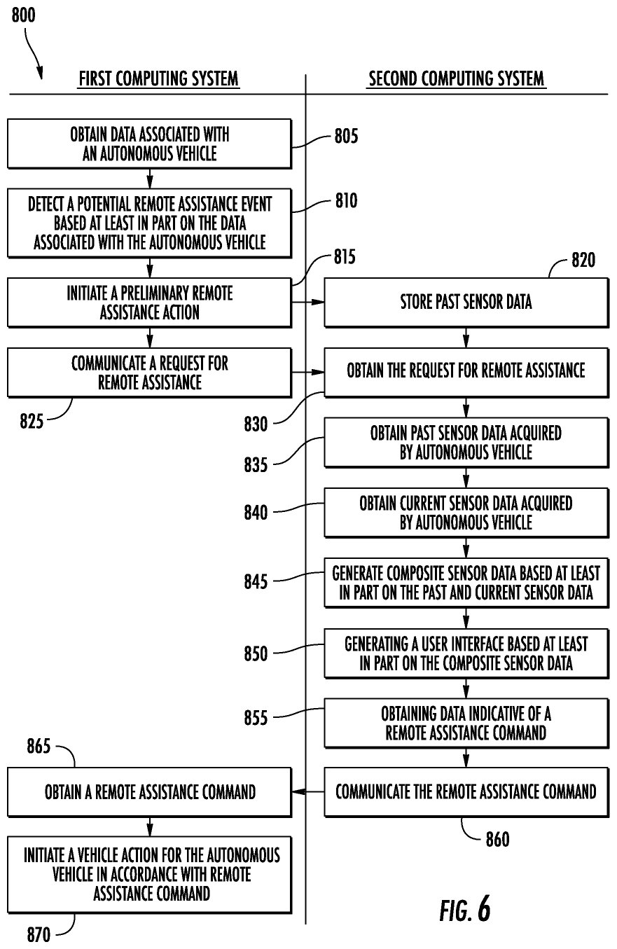

FIG. 6 depicts a flowchart illustrating an example method 800 for autonomous vehicle remote assistance according to example embodiments of the present disclosure. One or more portion(s) of the method 800 can be implemented by one or more computing devices such as, for example, the computing devices/interfaces described in FIGS. 1, 2, 3, 5, 7 and 8. Moreover, one or more portion(s) of the method 800 can be implemented as an algorithm on the hardware components of the device(s) described herein (e.g., as in FIGS. 1, 2, 3, 5, 7 and 8) to, for example, provide autonomous vehicle remote assistance. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (805), the method 800 can include obtaining data associated with an autonomous vehicle. For instance, a first computing system (e.g., a vehicle computing system, other computing system, etc.) can obtain data associated with an autonomous vehicle. The data associated with the autonomous vehicle can include at least one of data associated with a geographic area in which the autonomous vehicle is or will be located, interior sensor data associated with an interior of the autonomous vehicle, and/or external sensor data associated with a surrounding environment of the autonomous vehicle. Additionally, or alternatively, the data associated with the autonomous vehicle can include other types of data such as, for example, data communicated directly (e.g., via vehicle-to-vehicle communications, etc.) and/or indirectly (e.g., via a third party computing system, service entity computing system, etc.) to the first computing system from another vehicle. The data communicated from another vehicle can be indicative of a potential remote assistance event.

At (810), the method 800 can include detecting a potential remote assistance event based at least in part on the data associated with the autonomous vehicle. For instance, the first computing system can detect a potential remote assistance event based at least in part on the data associated with the autonomous vehicle. As described herein, the first computing system can determine a confidence associated with the potential remote assistance event. This can be done based on an analysis of the data associated with the autonomous vehicle (e.g., to perceive object(s) vehicle's surrounding environment, detect an interior vehicle problem, etc.). The first computing system can detect the potential remote assistance event based at least in part on a comparison of the confidence to a first threshold (e.g., a confidence threshold 510A, etc.).

At (815), the method 800 can include initiating a preliminary remote assistance action. For instance, the first computing system can initiate a preliminary remote assistance action based at least in part on the potential remote assistance event. The preliminary remote assistance action can include at least one of transmitting sensor data acquired by the autonomous vehicle to a remote computing system (e.g., a second computing system, etc.) and/or storing the sensor data onboard the autonomous vehicle. As described herein, initiating the preliminary remote assistance action can include selecting (e.g., by the first computing system, etc.) a type of preliminary remote assistance action (e.g., onboard sensor data buffering and/or offboard sensor data buffering, etc.). Additionally, or alternatively, initiating the preliminary remote assistance action can include determining (e.g., by the first computing system, etc.) one or more data attributes for the sensor data. The data attributes can include at least one of a frequency of the sensor data, a quality of the sensor data, and/or a resolution of the sensor data. As described herein, determining the one or more data attributes for the sensor data can include determining (e.g., by the first computing system, etc.) the one or more data attributes for the sensor data based at least in part on an object associated with the potential remote assistance event (e.g., type of object, whether an object is static, dynamic, typically dynamic, etc.). Additionally, or alternatively, the first computing system can determine one or more data attributes for the sensor data based at least in part on a first threshold (e.g., first threshold 510A, etc.). As described herein, the first computing system can update the one or more data attributes for the sensor data based at least in part on a second threshold (e.g., second threshold 510A, etc.).

The first computing system can initiate the preliminary remote assistance action by performing at least one of: transmitting sensor data acquired by the autonomous vehicle to a remote computing system (e.g., the second computing system, etc.) based at least in part on the one or more data attributes and/or storing the sensor data onboard the autonomous vehicle based at least in part on the one or more data attributes, as described herein. In the event that the first computing system transmits the sensor data acquired by the autonomous vehicle to the remote computing system (e.g., the second computing system, etc.), the past sensor data (e.g., acquired prior to a remote assistance request, etc.) can be stored remotely from the autonomous vehicle, at (820).

At (825), the method 800 can include communicating a request for remote assistance. For instance, the first computing system can communicate, after the initiation of the preliminary remote assistance action, a request for remote assistance of the autonomous vehicle. The request for remote assistance can indicate that the location of the autonomous vehicle, a unique identifier associated with the autonomous vehicle, data indicative of the remote assistance event (e.g., a classification, location, type of issue, etc. if determinable/known to the vehicle). The second computing system (e.g., a remote assistance system, other system remote from the autonomous vehicle, etc.) can obtain the remote assistance request for remote assistance of the autonomous vehicle, at (830).

The remote assistance request can trigger other data acquisitions by the second computing system. For instance, at (835), the method 800 can include obtaining past sensor data acquired by the autonomous vehicle. More particularly, the second computing system can obtain past sensor data acquired by the autonomous vehicle. The past sensor data can include the sensor data stored onboard the autonomous vehicle (e.g., in an onboard buffer, etc.) and/or remote from the autonomous vehicle (e.g., in an offboard buffer, etc.) based at least in part on a detection of a potential remote assistance event.

At (840), the method 800 can include obtaining current sensor data acquired by the autonomous vehicle. For instance, the second computing system can obtain a live stream of current sensor data acquired by the autonomous vehicle. As described herein, the current sensor data can be associated with the remote assistance event (e.g., indicative of a problem at least partially causing autonomous vehicle to communicate a remote assistance request, etc.) and can be presently collected by an autonomous vehicle. The transmission of this current sensor data can be triggered by the remote assistance event and/or request and start after the remote assistance event and/or request.

At (845), the method 800 can include generating composite sensor data based at least in part on the past and current sensor data. For instance, the second computing system can generate a composite sensor data set based at least in part on the past sensor data acquired by the autonomous vehicle and the live stream of the current sensor data acquired by the autonomous vehicle. As described herein, the second computing system can fuse the past sensor data and the current sensor data (e.g., past and current video image data, etc.) by processing these types of data to determine the timestamps associated with each frame and then sequentially stitching the frames in the order of their respective timestamps. The second computing system can continue to add to this composite sensor data set as additional current sensor data is received. This can produce an up-to-date composite sensor data set indicative of both the past sensor data and the current sensor data associated with the autonomous vehicle (and the remote assistance event).

At (850), the method 800 can include generating a user interface based at least in part on the composite sensor data. For instance, the second computing system can generate a user interface based at least in part on the composite sensor data. As described herein, the user interface can allow for playback of the past sensor data acquired by the autonomous vehicle and viewing of the current sensor data acquired by the autonomous vehicle.

At (855), the method 800 can include obtaining data indicative of a remote assistance command. For instance, the second computing system can obtain data indicative of a remote assistance command based at least in part on user input associated with the user interface. This can include, for example, user input provided by a remote assistance operator assigned to the remote assistance request. Additionally, or alternatively, the data indicative of the remote assistance command can be based at least in part on an automatic determination of the vehicle assistance command by the second computing system (e.g., a programmed/trained remote assistance event analyzer, etc.). The remote assistance command can include/be indicative of a vehicle action for the autonomous vehicle. The vehicle action can include, for example, a maneuver for the autonomous vehicle to avoid, overcome, address, etc. the remote assistance event. This can include, for example, a lane departure into an oncoming lane to move around a fallen tree. The second computing system can communicate the remote assistance command (e.g., a data package indicative thereof) to the first computing system (e.g., a vehicle computing system, etc.), at (860).

At (865), the method 865 can include obtaining a remote assistance command. For instance, the first computing system can obtain a remote assistance command indicative of a vehicle action for the autonomous vehicle. The first computing system can initiate the vehicle action for the autonomous vehicle, at (870). The first computing system can initiate a motion control of the autonomous vehicle in accordance with the vehicle action. By way of example, the first computing system can generate a motion plan with the motion trajectory for the autonomous vehicle to travel around a fallen tree and execute the trajectory via vehicle's control system(s). In some implementations, the first computing system can change the operating mode of the autonomous vehicle.

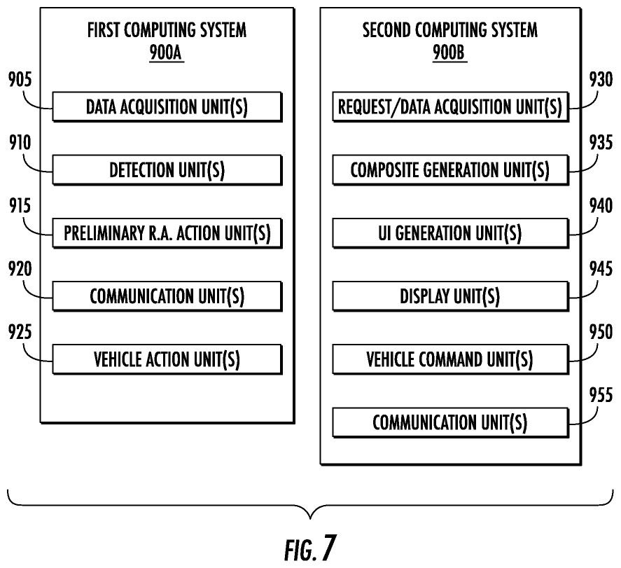

FIG. 7 depicts example systems 900A-B with units for performing operations and functions according to example aspects of the present disclosure. Various means can be configured to perform the methods and processes described herein. For example, a first computing system 900A can include data acquisition units(s) 905, detection units(s) 910, preliminary remote assistance action units(s) 915, communication unit(s) 920, vehicle action unit(s) 925, and/or other means for performing the operations and functions described herein. A second computing system 900B can include request/data acquisition units(s) 930, composite generation units(s) 935, user interface generation units(s) 940, display unit(s) 945, vehicle command unit(s) 950, communication unit(s) 955, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable logic array, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data associated with an autonomous vehicle. As described herein, the data associated with the autonomous vehicle can include sensor data (e.g., exterior, interior, etc.), map data, and/or other types of data. The data acquisition unit(s) 905 of the first computing system 900A are one example of means for obtaining data associated with an autonomous vehicle.

The means can be configured to detect a potential remote assistance event based at least in part on the data associated with the autonomous vehicle. As described herein, this detection can be based at least in part on a vehicle's confidence in the occurrence of the potential remote assistance event and/or a distance therefrom. The remote assistance event can be associated with the interior and/or exterior surrounding environment of the autonomous vehicle. The detection unit(s) 910 of the first computing system 900A are one example of means for detecting the potential remote assistance event.

The means can be configured to determine/initiate a preliminary remote assistance action based at least in part on the potential remote assistance event. As described herein, this can include selecting a type of preliminary remote assistance action and/or one or more data attribute(s) associated therewith. The preliminary remote assistance action can include, for example, at least one of transmitting sensor data acquired by the autonomous vehicle to a remote computing system or storing the sensor data onboard the autonomous vehicle. The preliminary remote assistance action unit(s) 915 of the first computing system 900A are one example of means for determining/initiating a preliminary remote assistance action.

The means can be configured to communicate, after the initiation of the preliminary remote assistance action, a request for remote assistance of the autonomous vehicle. As described herein, the autonomous vehicle can determine that a remote assistance event has occurred and request remote assistance for such an event. A remote assistance request can also initiate the release of buffered past sensor data for historical context of the remote assistance event. The communication unit(s) 920 of the first computing system 925 are one example of means for communicating a request for remote assistance of the autonomous vehicle.

The means can be configured to obtain the remote assistance request for remote assistance of the autonomous vehicle. This can be obtained by a computing system that is remote from the autonomous vehicle. The request/data acquisition unit(s) 930 of the second computing system 900B are one example of means for obtaining the remote assistance request for remote assistance of the autonomous vehicle.

The means can be configured to obtain sensor data from the autonomous vehicle. For example, the means can be configured to obtain past sensor data acquired by the autonomous vehicle. As described herein, the past sensor data can include sensor data stored onboard the autonomous vehicle or remote from the autonomous vehicle based at least in part on a detection of a potential remote assistance event (e.g., prior to the remote assistance request). The means can be configured obtain a live stream of current sensor data acquired by the autonomous vehicle. The request/data acquisition unit(s) 930 of the second computing system 900B are one example of means for obtaining the past sensor data and the live stream of current sensor data acquired by the autonomous vehicle.

The means can be configured to generate composite sensor data set based at least in part on the past sensor data acquired by the autonomous vehicle and the live stream of the current sensor data acquired by the autonomous vehicle. The composite sensor data can combine the past sensor data and the current sensor data to provide historical and current context of the remote assistance event, as described herein. The composite generation unit(s) 935 of the second computing system 900B are one example of means for generating composite sensor data.

The means can be configured to generate a user interface based at least in part on the composite sensor data. As described herein, the user interface can allow for playback of the past sensor data acquired by the autonomous vehicle and viewing of the current sensor data acquired by the autonomous vehicle. For example, the user interface can include a rendering of the sensor data and a user interface element for rewinding the sensor data to view rendered past sensor data. The user interface generation unit(s) 940 of the second computing system 900B are one example of means for generating a user interface based at least in part on the composite sensor data. The means can be configured to display the user interface. For example, data indicative of the user interface can be provided for display to a remote assistance operator via the display unit(s) 945 of the second computing system 900B, which are one example of means for displaying the user interface.

The means can be configured to determine a remote assistance command for an autonomous vehicle. For example, as described herein, the means can be configured to obtain data indicative of a remote assistance command based at least in part on user input associated with the user interface. Additionally, or alternatively, the means can be configured to automatically determine a remote assistance command (e.g., without user input, etc.). The remote assistance command can include a vehicle action for the autonomous vehicle. The vehicle command unit(s) 950 of the second computing system 900B are one example of means for obtaining/determining a remote assistance command. The means can be configured to communicate the remote assistance command to the autonomous vehicle. The communication unit(s) 955 of the second computing system 900B are one example of means for communicating the remote assistance command.

The means can be configured to obtain a remote assistance command indicative of a vehicle action for the autonomous vehicle. The communication unit(s) 920 of the first computing system 900A are one example of means for obtaining the remote assistance command indicative of a vehicle action for the autonomous vehicle. The means can be configured to initiate the vehicle action of the autonomous vehicle (e.g., such that the autonomous vehicle implements a motion control to perform/complete the vehicle action). The vehicle action unit(s) 925 of the first computing system 900A are one example of means for initiating the vehicle action of the autonomous vehicle.

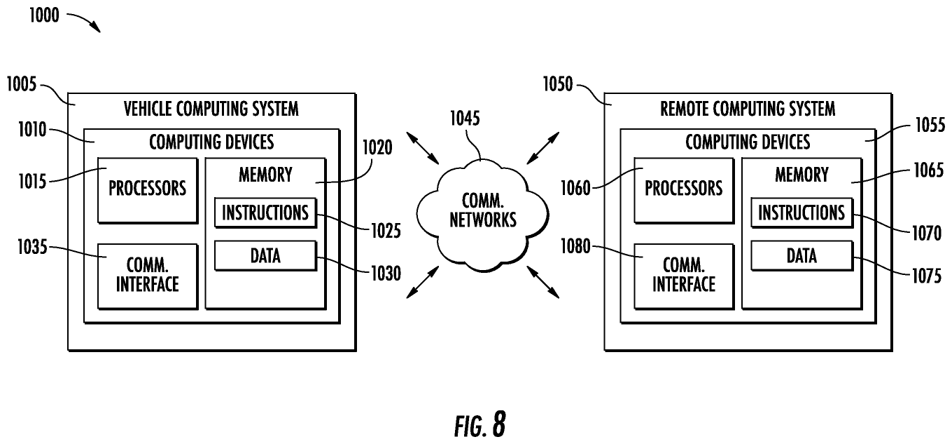

FIG. 8 depicts example system components of an example system 1000 according to example implementations of the present disclosure. The example system 1000 illustrated in FIG. 8 is provided as an example only. The components, systems, connections, and/or other aspects illustrated in FIG. 8 are optional and are provided as examples of what is possible, but not required, to implement the present disclosure. The example system 1000 can include a vehicle computing system 1005 (e.g., vehicle computing system 110, vehicle computing system 405, etc.) and a remote computing system 1050 (e.g., operations computing system 190A/320, implementing infrastructure 200, remote assistance system 410, etc.) that are communicatively coupled over one or more network(s) 1045 (e.g., network 120, etc.). As described herein, the vehicle computing system 1005 can be implemented onboard a vehicle (e.g., as a portion of the vehicle computing system 110, etc.) and/or can be remote from a vehicle (e.g., as a portion of an operations computing system, one or more remote computing systems, etc.).

The vehicle computing system 1005 can include one or computing device(s) 1010. The computing device(s) 1010 of the vehicle computing system 1005 can include processor(s) 1015 and a memory 1020. The one or more processor(s) 1015 can be any suitable processing device (e.g., a processor core, a microprocessor, an ASIC, a FPGA, a controller, a microcontroller, etc.) and can be one processor or a plurality of processors that are operatively connected. The memory 1020 can include one or more non-transitory computer-readable storage media, such as RAM, ROM, EEPROM, EPROM, one or more memory devices, flash memory devices, etc., and/or combinations thereof.

The memory 1020 can store information that can be obtained by the one or more processor(s) 1015. For instance, the memory 1020 (e.g., one or more non-transitory computer-readable storage mediums, memory devices, etc.) can include computer-readable instructions 1025 that can be executed by the one or more processor(s) 1015. The instructions 1025 can be software written in any suitable programming language or can be implemented in hardware. Additionally, or alternatively, the instructions 1025 can be executed in logically and/or virtually separate threads on processor(s) 1015.

For example, the memory 1020 can store instructions 1025 that when executed by the one or more processor(s) 1015 cause the one or more processor(s) 1015 to perform operations such as any of the operations and functions of the vehicle computing system(s) and/or for which the vehicle computing system(s) are configured, as described herein, the operations and functions for autonomous vehicle remote assistance (e.g., one or more portions of method 800), the operations and functions of any of the operations computing systems/remote computing systems/remote assistance computing systems and/or for which these systems are configured and/or any other operations and functions, as described herein.

The memory 1020 can store data 1030 that can be obtained (e.g., received, accessed, written, manipulated, generated, created, stored, etc.). The data 1030 can include, for instance, sensor data, map data, data generated by an autonomy system (e.g., perception data, prediction data, motion planning data, etc.), data associated with the autonomous vehicle as described herein, data indicative of a potential remote assistance event, data indicative of a preliminary remote assistance action, data indicative of a type of a preliminary indicative event, data structures, data indicative of confidences and/or thresholds, data attribute(s), past/buffered sensor data, communicability factors, current sensor data, data indicative of remote assistance events, data indicative of remote assistance requests, data indicative of remote assistance commands, data indicative of vehicle actions (in accordance with remote assistance commands), and/or other data/information described herein. In some implementations, the computing device(s) 1010 can obtain data from one or more memories that are remote from the vehicle computing system 1005.

The computing device(s) 1010 can also include a communication interface 1035 used to communicate with one or more other system(s) (e.g., other systems onboard and/or remote from a vehicle, the other systems of FIG. 8, etc.). The communication interface 1035 can include any circuits, components, software, etc. for communicating via one or more network(s) (e.g., network(s) 1045). In some implementations, the communication interface 1035 can include, for example, one or more of a communications controller, receiver, transceiver, transmitter, port, conductors, software and/or hardware for communicating data/information.

The remote computing system 1050 can include one or more computing device(s) 1055. The computing device(s) 1055 can include one or more processor(s) 1060 and at least one memory 1065. The one or more processor(s) 1060 can be any suitable processing device (e.g., a processor core, a microprocessor, an ASIC, a FPGA, a controller, a microcontroller, etc.) and can be one processor or a plurality of processors that are operatively connected. The memory 1065 can include one or more tangible, non-transitory computer-readable storage media, such as RAM, ROM, EEPROM, EPROM, one or more memory devices, flash memory devices, data registers, etc., and combinations thereof.

The memory 1065 can store information that can be accessed by the one or more processor(s) 1060. For instance, the memory 1065 (e.g., one or more tangible, non-transitory computer-readable storage media, one or more memory devices, etc.) can include computer-readable instructions 1070 that can be executed by the one or more processor(s) 1060. The instructions 1070 can be software written in any suitable programming language or can be implemented in hardware. Additionally, or alternatively, the instructions 1070 can be executed in logically and/or virtually separate threads on processor(s) 1060.

For example, the memory 1065 can store instructions 1070 that when executed by the one or more processor(s) 1060 cause the one or more processor(s) 1060 to perform operations such as any of the operations and functions of any of the operations computing systems/remote computing systems/remote assistance computing systems and/or for which these systems are configured operations, the operations and functions for autonomous vehicle remote assistance (e.g., one or more portions of method 800), any of the operations and functions of the vehicle computing system(s) and/or for which the vehicle computing system(s) are configured, as described herein, and/or any other operations and functions, as described herein.

The memory 1065 can store data 1075 that can be obtained and/or stored. The data 1075 can include, for instance, sensor data, map data, data associated with the autonomous vehicle as described herein, data indicative of a potential remote assistance event, data indicative of a preliminary remote assistance action, data indicative of a type of a preliminary indicative event, data structures, data indicative of confidences and/or thresholds, data attribute(s), past/buffered sensor data, communicability factors, current sensor data, data indicative of composite sensor data, data indicative of remote assistance events, data indicative of remote assistance requests, data indicative of remote assistance commands, data indicative of vehicle actions (in accordance with remote assistance commands), data indicative of user interfaces, and/or other data/information described herein.

The computing device(s) 1055 can also include a communication interface 1080 used to communicate with one or more other system(s) (e.g., the vehicle computing system 1005, etc.). The communication interface 1080 can include any circuits, components, software, etc. for communicating via one or more networks (e.g., network(s) 1045). In some implementations, the communication interface 1080 can include, for example, one or more of a communications controller, receiver, transceiver, transmitter, port, conductors, software, and/or hardware for communicating data.

The network(s) 1045 can be any type of network or combination of networks that allows for communication between devices. In some embodiments, the network(s) 1045 can include one or more of a local area network, wide area network, the Internet, secure network, cellular network, mesh network, peer-to-peer communication link and/or some combination thereof and can include any number of wired or wireless links. Communication over the network(s) 1045 can be accomplished, for instance, via a network interface using any type of protocol, protection scheme, encoding, format, packaging, etc.

Computing tasks discussed herein as being performed at a vehicle (e.g., via the vehicle computing system) can instead be performed by a remote computing system, or vice versa. Such configurations can be implemented without deviating from the scope of the present disclosure. Moreover, the present disclosure describes the use of buffers for storage of sensor data. Other types of memories can be utilized for such storage without deviating from the scope of the present disclosure.

The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for autonomous vehicle remote assistance, the method comprising:
obtaining, by a computing system comprising one or more computing devices, data associated with an autonomous vehicle;
detecting, by the computing system, a potential remote assistance event based at least in part on the data associated with the autonomous vehicle;
initiating, by the computing system, a preliminary remote assistance action based at least in part on the potential remote assistance event, wherein the preliminary remote assistance action comprises at least one of transmitting sensor data acquired by the autonomous vehicle to a remote computing system or storing the sensor data onboard the autonomous vehicle; and
communicating, by the computing system after the initiation of the preliminary remote assistance action, a request for remote assistance of the autonomous vehicle.

2. The computer-implemented method of claim 1, wherein initiating the preliminary remote assistance action comprises determining one or more data attributes for the sensor data.

3. The computer-implemented method of claim 2, wherein the data attributes comprise at least one of a frequency of the sensor data, a quality of the sensor data, or a resolution of the sensor data.

4. The computer-implemented method of claim 2, wherein determining the one or more data attributes for the sensor data comprises determining the one or more data attributes for the sensor data based at least in part on an object associated with the potential remote assistance event.

5. The computer-implemented method of claim 2, wherein initiating the preliminary remote assistance action comprises at least one of transmitting sensor data acquired by the autonomous vehicle to the remote computing system based at least in part on the one or more data attributes or storing the sensor data onboard the autonomous vehicle based at least in part on the one or more data attributes.

6. The computer-implemented method of claim 1, wherein detecting the potential remote assistance event based at least in part on the data associated with the autonomous vehicle comprises:
determining, by the computing system, a confidence associated with the potential remote assistance event; and
detecting, by the computing system, the potential remote assistance event based at least in part on a comparison of the confidence to a first threshold.

7. The computer-implemented method of claim 6, wherein initiating the preliminary remote assistance action comprises determining one or more data attributes for the sensor data based at least in part on the first threshold.

8. The computer-implemented method of claim 7, further comprising updating the one or more data attributes for the sensor data based at least in part on a second threshold.

9. The computer-implemented method of claim 1, wherein the data associated with the autonomous vehicle comprises at least one of data associated with a geographic area in which the autonomous vehicle is or will be located, interior sensor data associated with an interior of the autonomous vehicle, or external sensor data associated with a surrounding environment of the autonomous vehicle.

10. The computer-implemented method of claim 1, wherein the method further comprises:
obtaining, by the computing system, a remote assistance command indicative of a vehicle action for the autonomous vehicle; and
initiating, by the computing system, the vehicle action for the autonomous vehicle.

11. An autonomous vehicle comprising:
one or more processors; and
one or more tangible, non-transitory, computer readable media that collectively store instructions that when executed by the one or more processors cause the one or more processors to perform operations, the operations comprising:
detecting a potential remote assistance event based at least in part on data associated with the autonomous vehicle;
in response to detecting the potential remote assistance event, determining one or more data attributes for a preliminary remote assistance action;
initiating a preliminary remote assistance action based at least in part on the one or more data attributes, wherein the preliminary remote assistance action comprises at least one of transmitting sensor data acquired by the autonomous vehicle to a remote computing system or storing the sensor data onboard the autonomous vehicle; and
after the initiation of the preliminary remote assistance action, communicating a remote assistance request for remote assistance of the autonomous vehicle.

12. The autonomous vehicle of claim 11, wherein the preliminary remote assistance action comprises storing the sensor data onboard the autonomous vehicle and wherein communicating the remote assistance request for remote assistance of the autonomous vehicle comprises:
initiating the transmission of the sensor data stored onboard the autonomous vehicle to the remote computing system.

13. The autonomous vehicle of claim 12, wherein the sensor data stored onboard the autonomous vehicle is transmitted to the remote computing system prior to assignment of the remote assistance request to a remote assistance operator.

14. The autonomous vehicle of claim 11, wherein the preliminary remote assistance action comprises transmitting the sensor data acquired by the autonomous vehicle to the remote computing system, wherein the sensor data is stored by the remote computing system in an buffer remote from the autonomous vehicle, and wherein the sensor data is accessed from the buffer in response to the remote assistance request.

15. The autonomous vehicle of claim 11, wherein communicating the remote assistance request for remote assistance of the autonomous vehicle comprises initiating a live stream of current sensor data of the autonomous vehicle to the remote computing system.

16. The autonomous vehicle of claim 11, wherein the operations comprise:
obtaining a remote assistance command indicative of a vehicle action for the autonomous vehicle; and
initiating a motion control of the autonomous vehicle in accordance with the vehicle action.

17. The autonomous vehicle of claim 11, wherein the one or more data attributes comprise a frequency of the sensor data and wherein the frequency of the sensor data is associated with a type of an object associated with the potential remote assistance event.

18. The autonomous vehicle of claim 11, wherein the operations further comprise:
selecting the preliminary remote assistance action based at least in part on a confidence associated with the potential remote assistance event.

19. A computing system comprising:
one or more processors; and
one or more tangible, non-transitory, computer readable media that collectively store instructions that when executed by the one or more processors cause the computing system to perform operations, the operations comprising:
obtaining a remote assistance request for remote assistance of the autonomous vehicle;
obtaining past sensor data acquired by the autonomous vehicle, wherein the past sensor data was stored onboard the autonomous vehicle or remote from the autonomous vehicle based at least in part on a detection of a potential remote assistance event;
obtaining a live stream of current sensor data acquired by the autonomous vehicle;
generating a composite sensor data set based at least in part on the past sensor data acquired by the autonomous vehicle and the live stream of the current sensor data acquired by the autonomous vehicle; and
generating a user interface based at least in part on the composite sensor data, the user interface allowing for playback of the past sensor data acquired by the autonomous vehicle and viewing of the current sensor data acquired by the autonomous vehicle.

20. The computing system of claim 19, wherein the operations further comprise:
obtaining data indicative of a remote assistance command based at least in part on user input associated with the user interface, the remote assistance command indicating a vehicle action for the autonomous vehicle; and
communicating the remote assistance command to the autonomous vehicle.
